(19) United States
(12) Patent Application Publication
(10) Pub. No.: US 2015/0002789 A1
(43) Pub. Date: Jan. 1, 2015

(54) OPTICALLY-COMPENSATORY FILM, POLARIZING PLATE, LIQUID CRYSTAL DISPLAY, AND METHOD OF PRODUCING OPTICALLY-COMPENSATORY FILM

(71) Applicant: FUJIFILM Corporation, Tokyo (JP)

(72) Inventors: Hiroyuki KAIHOKO, Kanagawa (JP); Yuki MATSUDA, Kanagawa (JP); Tatsuya IWASAKI, Kanagawa (JP); Shunya KATOH, Kanagawa (JP); Hiroshi MATSUYAMA, Kanagawa (JP); Toshiyuki SAIKI, Kanagawa (JP)

(73) Assignee: FUJIFILM Corporation, Tokyo (JP)

(21) Appl. No.: 14/315,975

(22) Filed: Jun. 26, 2014

(30) Foreign Application Priority Data
Jun. 28, 2013 (JP) 2013-135841
May 27, 2014 (JP) 2014-109322
Jun. 16, 2014 (JP) 2014-123580

(51) Int. Cl. G02F 1/13363; G02F 1/1337; G02F 1/1335; G02B 5/30; G02F 1/1347

(52) U.S. Cl. CPC G02F 1/13363; G02B 5/3016; G02F 1/1347; G02F 1/133528; G02F 1/133788; G02F 1/133711; G02F 2001/133638; G02F 2001/133354
USPC 349/75; 349/96; 427/558

(57) ABSTRACT

To provide an optically-compensatory film that can improve the contrast, to provide a polarizing plate and a liquid crystal display including the optically-compensatory film and a method of producing the optically-compensatory film. An optically-compensatory film including a transparent support; and at least one optically anisotropic layer including a liquid crystal composition containing liquid crystal compounds, in the transparent support; wherein when the optically-compensatory film is disposed between two polarizing plates in a cross nicol state, degree of depolarization as seen from the front face is 0.000022 or less, and degree of depolarization as seen from a polar angle of 50° from an absorption axis direction of one of the polarizing plates is 0.00077 or less.

### CROSS-REFERENCE TO RELATED APPLICATIONS

The present application claims the benefit of priority from Japanese Patent Application No. 135841/2013, filed on Jun. 28, 2013, Japanese Patent Application No. 109322/2014, filed on May 27, 2014, and Japanese Patent Application No. 123580/2014, filed on Jun. 16, 2014, the content of which are herein incorporated by reference in their entirety.

### BACKGROUND OF THE INVENTION

1. Field of the Invention

The present invention relates to an optically-compensatory film that is applicable to a liquid crystal display, a method of producing the film, and a polarizing plate and a liquid crystal display including the optically-compensatory films.

2. Description of the Related Art

A liquid crystal display (LCD) includes a liquid crystal cell and a pair of polarizing plates sandwiching the cell. A polarizing plate generally includes protective films made of cellulose acetate and a polarizing film and is prepared by, for example, dyeing a polyvinyl alcohol film as the polarizing film with iodine, stretching the film, and disposing protective films on both surfaces of the polarizing film.

In order to compensate distortion in an image viewed from various viewing angles due to retardation of polarized light passing through a liquid crystal cell, one or more retardation films may be disposed adjacent to the protective film. The retardation film is also called an optically-compensatory film. The retardation film can also function as a protective film of a polarizing plate by laminating directly onto a polarizing film.

A liquid crystal cell switches ON and OFF displays depending on a variation in alignment state of the liquid crystal molecules. Several display modes have been proposed, for example, twisted nematic (TN), in-plane switching (IPS), optically compensatory bend (OCB), vertically aligned (VA), and electrically controlled birefringence (ECB).

National Publication of International Patent Application No. 2006-520008 and Japanese Patent Laid-Open Nos. 2007-17637 and 2010-185937 disclose technology for preventing a reduction in contrast of an IPS liquid crystal display in an oblique view angle by applying an optically-compensatory film including a negative biaxial retardation film and a positive C-plate to the liquid crystal display.

This technology can improve the contrast in oblique directions. IPS liquid crystal cells have been applied to cellular phones, smartphones, and tablets. These devices require high contrast in all oblique view angles, i.e., vertical (upward and downward) and horizontal (rightward and leftward) view angles.

As described in embodiments of National Publication of International Patent Application No. 2006-520008 and Japanese Patent Laid-Open No. 2007-17637, the positive C-plate includes an ultraviolet cured vertical alignment film, and it is believed that the vertical alignment of liquid crystals is a shortcut for achieving high contrast. In the vertical alignment of liquid crystal molecules, the major axes of the liquid crystal molecules are aligned in the direction substantially orthogonal to a substrate. It is well known that the vertical alignment is obtained by applying an electric field to liquid crystals disposed between two glass substrates, as in a liquid crystal display; however, formation of a film with this alignment state is very difficult and has problems as reported in Japanese Patent Laid-Open No. 2007-17637. It is also known that disorder of alignment due to thermal fluctuation and light leakage due to unevenness of alignment occur in liquid crystals. These phenomena may cause a reduction in contrast. Unfortunately, the above-mentioned reports mention no countermeasure to such problems.

Meanwhile, Japanese Patent Laid-Open No. 2010-185937 discloses a method of using a styrene or acrylic resin instead of the use of the vertical alignment of liquid crystals in a positive C-plate. Unfortunately, the thickness necessary for causing retardation in optical compensation is 60 μm in this method, which thickness is significantly greater than 1 to 2 μm in the case of using liquid crystals.

The present inventors, who have extensively studied liquid crystal displays utilizing vertical alignment of liquid crystals, have found that such displays have a problem in the contrast (CR) in oblique directions, in particular, in the upward and downward views of the display is lower than those of other types of liquid crystal display systems. In recent years, high CR liquid crystal displays have been developed, and it has been highly demanded to improve the front CR also in liquid crystal displays of IPS modes.

### SUMMARY OF THE INVENTION

An object of the present invention, which has been made from the above viewpoint, is to provide an optically-compensatory film that can improve the contrast in all oblique view angles, i.e., vertical (upward and downward) and horizontal (rightward and leftward) view angles.

Another object of the present invention is to provide a polarizing plate and a liquid crystal display including the optically-compensatory film and a method of producing the optically-compensatory film.

The problems were solved by the configuration <1>, preferably by configurations <2> to <23> below.

<1> An optically-compensatory film comprising: a transparent support; and at least one optically anisotropic layer comprising a liquid crystal composition containing liquid crystal compounds, in the transparent support; wherein when the optically-compensatory film is disposed between two polarizing plates in a cross nicol state, degree of depolarization as seen from the front face is 0.000022 or less, and degree of depolarization as seen from a polar angle of 500 from an absorption axis direction of one of the polarizing plates is 0.00077 or less, wherein the degree of depolarization D is represented by

D=Lmin/Lmax−L₀min/L₀max

wherein Lmin denotes the minimum luminance of the optically-compensatory film disposed between two polarizing plates in a cross nicol state; Lmax denotes the maximum luminance of the optically-compensatory film disposed between two polarizing plates in a parallel nicol state; L₀min denotes the minimum luminance of two polarizing plates in a cross nicol state; and L₀max denotes the maximum luminance of two polarizing plates in a parallel nicol state.
<2> The optically-compensatory film according to <1>, wherein the liquid crystal compounds are vertically aligned.
<3> The optically-compensatory film according to <1> or <2>, wherein the liquid crystal compounds have a polymerizable group, and the liquid crystal compounds after polymerization have an order parameter of 0.55 or more, wherein the order parameter S is represented by

S=(A_{∥}−A_{⊥})/(2A_{⊥}+A_{∥}),

wherein “A_{∥}” denotes absorbance of light polarized in parallel to the alignment direction of liquid crystal compounds; and “A_{⊥}” denotes absorbance of light polarized perpendicular to the alignment direction of liquid crystal compounds.
<4> The optically-compensatory film according to any one of <1> to <3>, wherein the liquid crystal composition contains at least two kinds of liquid crystal compounds selected from a liquid crystal compound represented by Formula (1), a liquid crystal compound represented by Formula (2), and a liquid crystal compound represented by Formula (3);

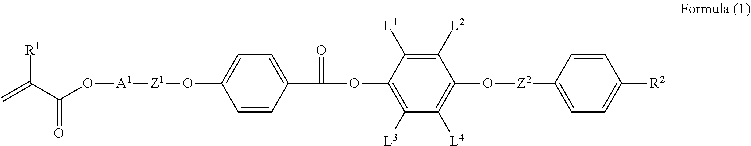

wherein A¹ represents a polymethylene group having 2 to 18 carbon atoms, in which one or non-adjacent two or more CH₂ groups of the polymethylene group are optionally substituted with —O—; Z¹ represents —CO—, —O—CO—, or a single bond; Z² represents —CO— or —CO—CH═CH—; R¹ represents a hydrogen atom or a methyl group; R² represents a hydrogen atom, a halogen atom, a linear alkyl group having 1 to 4 carbon atoms, a methoxy group, an ethoxy group, an optionally substituted phenyl group, a vinyl group, a formyl group, a nitro group, a cyano group, an acetyl group, an acetoxy group, an N-acetylamido group, an N-acrylamido group, an N,N-dimethylamino group, or a maleimide group; L¹, L², L³, and L⁴ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L¹, L², L³, and L⁴ represents a group other than a hydrogen atom;

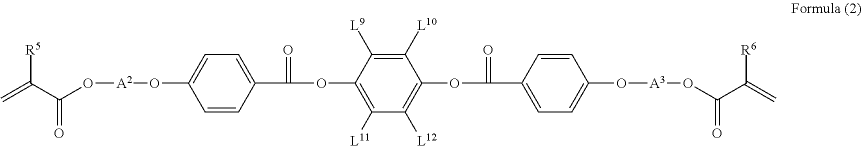

wherein A² and A³ each independently represent a polymethylene group having 2 to 18 carbon atoms, in which one or non-adjacent two or more CH₂ groups of the polymethylene group are optionally substituted with —O—; R⁵ and R⁶ each independently represent a hydrogen atom or a methyl group; L⁹, L¹⁰, L¹¹, and L¹² each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L⁹, L¹⁰, L¹¹, and L¹² represents a group other than a hydrogen atom;

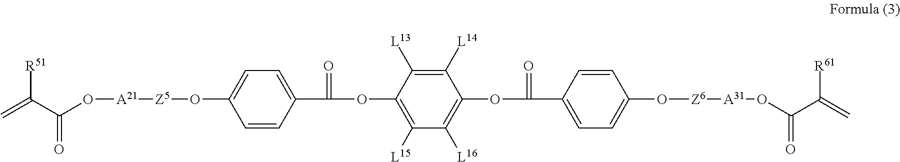

where, A²¹ and A³¹ each independently represent a polymethylene group having 2 to 18 carbon atoms, in which one or non-adjacent two or more CH₂ groups of the polymethylene group are optionally substituted with —O—; Z⁵ represents —CO— or —O—CO—; Z⁶ represents —CO— or —CO—O—; R⁵¹ and R⁶¹ each independently represent a hydrogen atom or a methyl group; L¹³, L¹⁴, L¹⁵, and L¹⁶ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L¹³, L¹⁴, L¹⁵, and L¹⁶ represents a group other than a hydrogen atom.
<5> The optically-compensatory film according to <4>, wherein the two liquid crystal compounds are mixed at a mixing ratio of 80:20 to 95:5, the mixing ratio being mass ratio.
<6> The optically-compensatory film according to any one of <1> to <5>, wherein the optically-compensatory film is formed by coating a liquid crystal composition containing liquid crystal compounds in a transparent support or on an alignment film disposed on a surface of a transparent support, aligning the liquid crystal compounds in a predetermined alignment state by maintaining the temperature at which the liquid crystal compounds form a liquid crystal phase, and fixing the alignment state of the liquid crystal compounds by ultraviolet ray irradiation at a predetermined temperature.
<7> The optically-compensatory film according to any one of <1> to <6>, comprising an alignment film containing a (meth)acrylic resin between the transparent support and the optically anisotropic layer.
<8> The optically-compensatory film according to <6> or <7>, wherein the alignment film is formed by coating an alignment film composition containing a (meth)acrylic resin onto a transparent support and drying the coating at 10° C. to 60° C.
<9> The optically-compensatory film according to <7> or <8>, wherein the alignment film is formed by coating an alignment film composition having a solid content of 10% to 60% by mass onto a transparent support and drying the coating.
<10> The optically-compensatory film according to any one of <1> to <9>, comprising an alignment film formed by coating an alignment film composition containing an acrylic resin onto a transparent support and drying the coated alignment film composition, wherein the optically-compensatory film is formed by aligning the liquid crystal compounds in a predetermined alignment state by maintaining the temperature at which the liquid crystal compounds form a liquid crystal phase and fixing the alignment state of the liquid crystal compounds by ultraviolet ray irradiation at 30° C. to 60° C.
<11> The optically-compensatory film according to any one of <1> to <10>, wherein the optically anisotropic layer has a retardation in the thickness direction Rth(550) of −200 to −100 nm at a wavelength 550 nm.
<12> The optically-compensatory film according to any one of <1> to <11>, wherein the transparent support has a retardation in-plane Re(550) of 70 nm or less and a retardation in the thickness direction Rth(550) of 0 to 200 nm at a wavelength 550 nm.
<13> The optically-compensatory film according to any one of <1> to <12>, wherein the transparent support is a cellulose acylate-based film, a cyclic olefin polymer film, or an acrylic polymer film.
<14> The optically-compensatory film according to <13>, wherein the transparent support is formed of a composition containing a cellulose acylate including an acyl group having an aromatic group.
<15> A polarizing plate comprising an optically-compensatory film according to any one of <1> to <14> and a polarizing film.
<16> The polarizing plate according to <15>, wherein the optically-compensatory film and the polarizing film are directly bonded to each other with an adhesive and/or a pressure-sensitive adhesive.
<17> The polarizing plate according to <15> or <16>, comprising a protective film on the surface of the polarizing film at the opposite side of the optically-compensatory film.
<18> The polarizing plate according to <17>, wherein the protective film is selected from cellulose acylate-based films, cyclic olefin polymer films, acrylic polymer films, polypropylene films, and polyethylene terephthalate films.
<19> The polarizing plate according to <17> or <18>, wherein the protective film has a thickness of 10 to 90 μm.
<20> The polarizing plate according to any one of <15> to <19>, wherein the polarizing film has a thickness of 50 μm or less.
<21> An IPS mode or FFS mode liquid crystal display comprising an optically-compensatory film according to any one of <1> to <14> or a polarizing plate according to any one of <15> to <20>.
<22> A method of producing an optically-compensatory film according to any one of <1> to <14>, the method comprising: coating a liquid crystal composition containing a liquid crystal compound onto a transparent support; aligning the liquid crystal compound in a predetermined alignment state by maintaining the temperature at which the liquid crystal compound forms a liquid crystal phase; and fixing the alignment state of the liquid crystal compound by ultraviolet ray irradiation at 30° C. to 60° C.
<23> The method according to <22>, comprising: applying an alignment film composition containing a (meth)acrylic resin and having a solid content of 30% by mass or more onto a transparent support; drying the coating at 10° C. to 40° C. to form an alignment film; and applying a liquid crystal composition containing a liquid crystal compound onto the surface of the alignment film.

According to the present invention, the contrast of a liquid crystal display can be increased by applying an optically-compensatory film having specific properties to the liquid crystal display or by modifying the process of producing the optically-compensatory film, with no modification in the liquid crystal cells of the liquid crystal display.

### BRIEF DESCRIPTION OF THE DRAWING

FIG. 1 is a graph showing an exemplary relationship between the order parameter and the NI point and curing temperature.

### DETAILED DESCRIPTION OF THE PREFERRED EMBODIMENTS

The contents of the invention are described in detail hereinunder. In this description, the numerical range expressed by the wording “a number to another number” means the range that falls between the former number indicating the lowermost limit of the range and the latter number indicating the uppermost limit thereof.

In this description, “(meth)acrylate” means acrylate and methacrylate; “(meth)acrylic” means acrylic and methacrylic; “(meth)acryloyl” means acryloyl and methacryloyl.

### <Optically-Compensatory Film>

The optically-compensatory film of the present invention includes a transparent support and at least one optically anisotropic layer composed of a liquid crystal composition comprising liquid crystal compounds in the transparent support, wherein

when the optically-compensatory film is disposed between two polarizing plates in a cross nicol state, the degree of depolarization as seen from the front is 0.000022 or less, and the degree of depolarization as seen from a polar angle of 500 from the absorption axis direction of one of the polarizing plates is 0.00077 or less. The degree of depolarization D is represented by

D=Lmin/Lmax−L₀min/L₀max

where,
Lmin denotes the minimum luminance of the optically-compensatory film disposed between two polarizing plates in a cross nicol state;

Lmax denotes the maximum luminance of the optically-compensatory film disposed between two polarizing plates in a parallel nicol state;

L₀min denotes the minimum luminance of two polarizing plates in a cross nicol state; and

L₀max denotes the maximum luminance of two polarizing plates in a parallel nicol state.

The present inventors have investigated causes of the low contrast in oblique directions of a liquid crystal display utilizing vertical alignment of liquid crystals. The inventors have revealed that one of the causes is a deteriorated depolarization as seen from an oblique direction of the optically-compensatory film and have successfully improved the contrast by improving the degree of depolarization. A further investigation revealed that the alignment fluctuation of liquid crystal of the optically-compensatory film tends to deteriorate the alignment order parameter (order parameter) and thus to cause light scattering. It was revealed that an improvement in the order parameter decreases the degree of depolarization to significantly improve the contrast in horizontal and vertical view angles of the liquid crystal display.

The method of the present invention can decrease the degree of depolarization in oblique directions of an optically-compensatory film by, in the formation of an optically anisotropic layer, for example, selecting two or more specific liquid crystal compounds and adding the compounds at a predetermined proportion to the layer, adding a predetermined additive to the layer, optimizing the material of the alignment film for vertically aligning liquid crystal compounds or the temperature at ultraviolet-ray irradiation for alignment curing, or optimizing the temperature for alignment drying. As a result, the reduction in contrast (CR) due to light scattering of liquid crystals by alignment fluctuation can be decreased. The influence of liquid crystal scattering on the contrast in oblique directions has not ever been investigated, and the present inventors have first found the influence.

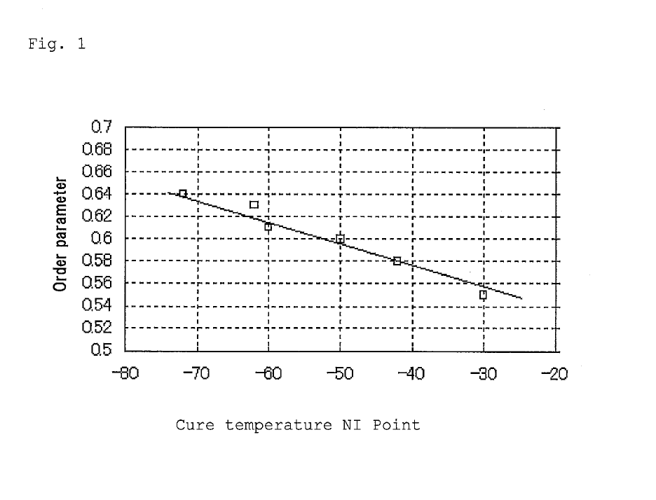

The inventor investigated and found that as shown in an example in FIG. 1, the order parameter tends to become high in accordance with the increase of the NI point (nematic-isotropic transition temperature) of the liquid crystal compound.

The inventors also investigated that when the correlation of the order parameter with the temperature for alignment curing using liquid crystal compounds is reviewed, the orderparameter tends to become high in accordance with the increase in temperature for alignment curing.

Alignment disorder in an alignment film vertically aligning liquid crystal compounds is caused by migration of, for example, an additive from a support into the liquid crystal compound to reduce the order parameter. Effective measures to prevent the reduction include increases in contents of materials, selection of a material that can inhibit migration of additives, and optimization of the drying temperature. A lower temperature of ultraviolet (UV) ray irradiation for alignment curing is effective, but an excessively low temperature causes a problem of insufficient polymerization for curing. Accordingly, optimization of the temperature is necessary. In the present invention, a degree of depolarization of 0.00077 or less can be achieved by combining these measures for improving the order parameter.

Haze is often used as a physical property that generally affects the contrast. The haze is represented by the ratio of the total transmitted light intensity of an optically-compensatory film to the total light intensity from a diffused light source. Table 1 shows the results of investigation by the present inventors. The haze cannot sufficiently detect a difference in contrast in an oblique direction. In addition, the light from a diffused light source passes through the polarizing plate and the polarized light enters the optically-compensatory film in an actual liquid crystal display; hence, the haze differs from that in an actual measurement system. The degree of depolarization as seen from an oblique direction in the present invention is that of a measurement system in which actual polarized light enters and is therefore correlative to the contrast (CR) of a liquid crystal display. Thus, the improvement of the measurement system also highly contributes to the present invention.

TABLE 1

| | Oblique | Degree of depolarization | |
|---|---|---|---|
| | direction | as seen from an oblique | |
| | CR | direction | Haze |
| Sample 1 | 335 | 0.00118 | 0.10 |
| Sample 2 | 346 | 0.00080 | 0.10 |
| Sample 3 | 364 | 0.00069 | 0.11 |
| Sample 4 | 402 | 0.00059 | 0.10 |
| Sample 5 | 430 | 0.00050 | 0.09 |

In the optically-compensatory film of the present invention disposed between two polarizing plates in a cross nicol state, the degree of depolarization as seen from the front is measured based on (the minimum luminance of the optically-compensatory film disposed between two polarizing plates in a cross nicol state)/(the maximum luminance of the optically-compensatory film disposed between two polarizing plates in a parallel nicol state). The degree of depolarization as seen from the front in the present invention is 0.000022 or less, preferably 0.000020 or less, and more preferably 0.000018 or less.

In an optically-compensatory film of the present invention disposed between two polarizing plates in a cross nicol state, the degree of depolarization as seen from a polar angle of 500 from the absorption axis direction of one of the polarizing plates is 0.00077 or less, preferably 0.00067 or less, and more preferably 0.00059 or less.

These ranges will contribute to a further improvement in the contrast.

### <<Optically Anisotropic Layer>>

The optically-compensatory film of the present invention includes an optically anisotropic layer composed of a liquid crystal composition comprising liquid crystal compounds in a transparent support. The optically anisotropic layer is preferably formed on an alignment film that has been formed on a transparent support in advance.

Alternatively, a polarizing plate provided with an optically-compensatory film of the present invention can be produced by transferring a liquid crystal compound layer formed on another substrate on or in a transparent support with, for example, an adhesive. In such a case, the substrate temporarily supporting the optically anisotropic layer may not be transparent, but the support to which the layer is transferred is a transparent support.

The liquid crystal compound contained in the optically anisotropic layer is preferably vertically aligned. The liquid crystal compound contained in the optically anisotropic layer has polymerizable groups, and the liquid crystal compound after polymerization preferably has an order parameter of 0.55 or more.

Here, the order parameter will be described. In order to generate optical anisotropy, an optical component needs to be aligned. The optical component here is that inducing anisotropy in refractive index. Examples of the optical component include discoid or rod-like liquid crystal molecules showing liquid crystal phases at certain temperature ranges and polymers that are aligned by, for example, stretching. The birefringence of a bulk of an optical component is determined by the birefringence inherent in the optical component and the statistical degree of alignment of the optical component. For example, the magnitude of the optical anisotropy of an optically anisotropic layer made of liquid crystal compounds is determined by the birefringence inherent in the liquid crystal compound as a main optical component generating the optical anisotropy and the statistical degree of alignment of the liquid crystal compound. An order parameter S is known as a parameter representing the degree of alignment. The alignment order parameter is defined as 1 for no distribution as in crystals and is defined as 0 for a completely random distribution as in a liquid state. For example, the alignment order parameter of a nematic liquid crystal is believed to be generally about 0.6. The order parameter S is described in detail in, for example, written by DE JEU, W. H., “Ekisyo no Bussei (Physical Properties of Liquid Crystal” (published by Kyoritu Shuppan Co., Ltd., 1991, p. 11) and is represented by the following expression:

$$S = \frac{1}{2} 〈 3 {cos}^{2} θ - 1 〉 \qquad [ Math . 1 ]$$

In the expression, θ denotes an angle formed by the average alignment direction of alignment elements and the axis of each alignment element.

The order parameter can be measured by, for example, a polarized Raman method, an IR method, an X-ray method, a fluorescence method, or a sonic speed method.

The order parameter (S value) can be determined based on a spectroscopic measurement with the following expression described in “A Handbook of Liquid Crystal Devices”, edited by Japan Society for the Promotion of Science, the 142nd Committee.

S=(A_{∥}−A_{⊥})/(2A_{⊥}+A_{∥}),

In the expression, “A_{∥}” and “A_{⊥}” respectively denote the absorbance of light polarized in parallel to and perpendicular to the alignment direction of liquid crystals. The S value is theoretically within a range of 0 to 1, and a value nearer to 1 is indicative of higher contrast of a liquid crystal device.

Since the expression is based on polarized absorption, the S value can be relatively readily determined for a liquid crystal compound having dichroism or a liquid crystal layer dyed with a dichroic dye.

The order parameter after the polymerization is preferably 0.55 or more, more preferably 0.6 or more, and most preferably 0.65 or more. Although the order parameter has no particularly upper limit, the upper limit may be, for example, 1.0 or less.

The optically anisotropic layer in the present invention is composed of a liquid crystal composition containing liquid crystal compounds.

Examples of the liquid crystal compound used for forming the optically anisotropic layer include rod-like liquid crystal compounds and discotic liquid crystal compounds. The rod-like liquid crystal compounds and the discotic liquid crystal compounds may be high-molecular liquid crystal or low-molecular liquid crystal or may be low-molecular liquid crystal that have been cross-linked and no longer exhibits liquid crystal properties.

Preferred examples of the rod-like liquid crystal compound that can be used in the present invention include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans, and alkenylcyclohexyl benzonitriles.

The rod-like liquid crystal compound may be a metal complex. Furthermore, a liquid crystal polymer comprising the rod-like liquid crystal compound in its repeating unit can also be used. In other words, the rod-like liquid crystal compound may be bonded to a (liquid crystal) polymer.

The rod-like liquid crystal compounds are described in Kikan, Kagaku Sosetsu (Quarterly Publication, Chemistry Reviews), Vol. 22, “Ekisho no Kagaku (Chemistry of Liquid Crystal) (1994), edited by The Chemical Society of Japan”, Chapters 4, 7, and 11 and in Ekisho Debaisu Handbukku (A Handbook of Liquid Crystal Devices), edited by Japan Society for the Promotion of Science, the 142nd Committee, Chapter 3.

The rod-like liquid crystal compound used in the present invention preferably has a birefringence of 0.001 to 0.7.

The rod-like liquid crystal compound preferably has polymerizable groups for fixing the alignment state thereof. The polymerizable groups are preferably unsaturated polymerizable groups or epoxy groups, more preferably unsaturated polymerizable groups, and most preferably ethylenically unsaturated polymerizable groups.

In order to that the optically anisotropic layer of the present invention has an order parameter of 0.55 or more after polymerization, the optically anisotropic layer preferably comprises at least two compounds selected from liquid crystal compounds represented by Formula (1), liquid crystal compounds represented by Formula (2), and compounds represented by Formula (3). The mixing ratio in a binary mixture is preferably 80:20 to 90:10.

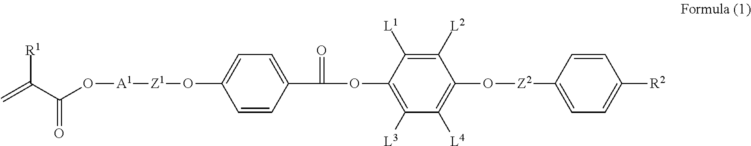

where,
A¹ represents a polymethylene group having 2 to 18 carbon atoms, in which one or non-adjacent two or more CH₂ groups of the polymethylene group are optionally substituted with —O—;
Z¹ represents —CO—, —O—CO—, or a single bond;
Z² represents —CO— or —CO—CH═CH—;
R¹ represents a hydrogen atom or a methyl group;
R² represents a hydrogen atom, a halogen atom, a linear alkyl group having 1 to 4 carbon atoms, a methoxy group, an ethoxy group, an optionally substituted phenyl group, a vinyl group, a formyl group, a nitro group, a cyano group, an acetyl group, an acetoxy group, an N-acetylamido group, an N-acrylamido group, an N,N-dimethylamino group, or a maleimide group; and
L¹, L², L³, and L⁴ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L¹, L², L³, and L⁴ represents a group other than a hydrogen atom.

A¹ represents a polymethylene group having 2 to 18 carbon atoms, in which one or non-adjacent two or more CH₂ groups of the polymethylene group are optionally substituted with —O—.

A¹ preferably represents a polymethylene group having 2 to 7 carbon atoms, more preferably a polymethylene group having 3 to 6 carbon atoms, and most preferably a polymethylene group having 3 or 4 carbon atoms. One or non-adjacent two or more CH₂ groups of the polymethylene group are optionally substituted with —O—. The number of CH₂ groups to be substituted with —O— in the polymethylene group is preferably 0 to 2, more preferably 0 or 1, and most preferably 0.

Z¹ represents —CO—, —O—CO—, or a single bond and preferably represents —O—CO— or a single bond.

Z² represents —CO— or —CO—CH═CH— and preferably represents —CO—.

R¹ represents a hydrogen atom or a methyl group and preferably represents a hydrogen atom.

R² represents a hydrogen atom, a linear alkyl group having 1 to 4 carbon atoms, a methoxy group, an ethoxy group, an aromatic ring optionally having a substituent, a cyclohexyl group, a vinyl group, a formyl group, a nitro group, a cyano group, an acetyl group, an acetoxy group, an N-acetylamido group, an N-acrylamido group, an N,N-dimethylamino group, or a maleimide group, preferably a linear alkyl group having 1 to 4 carbon atoms, a methoxy group, an ethoxy group, or a phenyl group, and more preferably a methyl group, an ethyl group, a propyl group, a methoxy group, an ethoxy group, or a phenyl group, and most preferably a methyl group, an ethyl group, a methoxy group, an ethoxy group, or a phenyl group.

In the compounds represented by Formula (1), L¹, L², L³, and L⁴ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom; and at least one of L¹, L², L³, and L⁴ represents a group other than a hydrogen atom.

The alkyl group having 1 to 4 carbon atoms is preferably a linear alkyl group having 1 to 4 carbon atoms, more preferably a methyl group or an ethyl group, and most preferably a methyl group.

The number of carbon atoms of the alkoxy group having 1 to 4 carbon atoms is preferably 1 or 2 and most preferably 1.

The number of carbon atoms of the alkoxycarbonyl group having 2 to 5 carbon atoms is preferably 2 to 4 and most preferably 2.

The halogen atom is preferably a chlorine atom.

L¹, L², L³, and L⁴ each independently represent, preferably, an alkyl group having 1 to 4 carbon atoms or a hydrogen atom.

At least one of L¹, L², L³, and L⁴ is preferably an alkyl group having 1 to 4 carbon atoms, more preferably a methyl group or an ethyl group, and most preferably a methyl group. Particularly preferred is that one of L¹, L², L³, and L⁴ is a methyl group, and the other three substituents are hydrogen atoms.

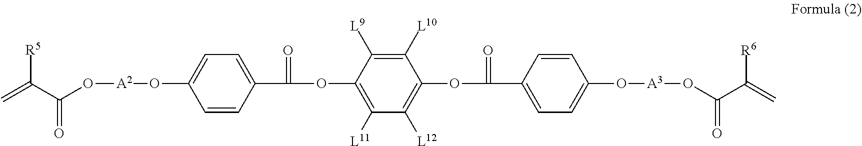

where,
A² and A³ each independently represent a polymethylene group having 2 to 18 carbon atoms, in which one or non-adjacent two or more CH₂ groups of the polymethylene group are optionally substituted with —O—;
R⁵ and R⁶ each independently represent a hydrogen atom or a methyl group; and
L⁹, L¹⁰, L¹¹, and L¹² each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L⁹, L¹⁰, L¹¹, and L¹² represents a group other than a hydrogen atom.

A² and A³ each independently represent a polymethylene group having 2 to 18 carbon atoms, in which one or non-adjacent two or more CH₂ groups of the polymethylene group are optionally substituted with —O—.

A² and A³ each independently represent preferably a polymethylene group having 2 to 7 carbon atoms and more preferably a polymethylene group having 3 to 6 carbon atoms. A² and A³ are most preferably polymethylene groups having 4 carbon atoms. One or non-adjacent two or more CH₂ groups of the polymethylene group are optionally substituted with —O—. The number of CH₂ groups to be substituted with —O— in the polymethylene group is preferably 0 to 2, more preferably 0 or 1, and most preferably 0.

R⁵ and R⁶ each independently represent a hydrogen atom or a methyl group and preferably a hydrogen atom.

L⁹, L¹⁰, L¹¹, and L¹² are respectively synonymous with L¹, L², L³, and L⁴ of compounds represented by Formula (1), and the preferred ranges are also the same.

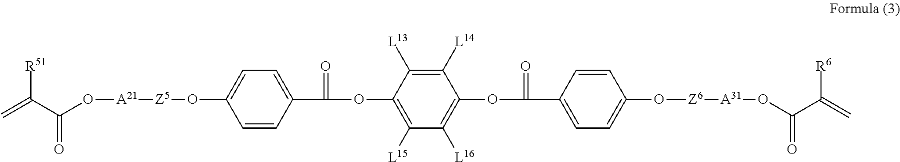

where,
A²¹ and A³¹ each independently represent a polymethylene group having 2 to 18 carbon atoms, in which one or non-adjacent two or more CH₂ groups of the polymethylene group are optionally substituted with —O—;
Z⁵ represents —CO— or —O—CO—;
Z⁶ represents —CO— or —CO—O—;
R⁵¹ and R⁶¹ each independently represent a hydrogen atom or a methyl group; and
L¹³, L¹⁴, L¹⁵, and L¹⁶ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L¹³, L¹⁴, L¹⁵, and L¹⁶ represents a group other than a hydrogen atom.

A²¹ and A³¹ are respectively synonymous with A² and A³ of compounds represented by Formula (2), and the preferred ranges are also the same.

Z⁵ represents —CO— or —O—CO— and preferably represents —O—CO—.

Z⁶ represents —CO— or —CO—O— and preferably represents —CO—O—.

R⁵¹ and R⁶¹ each independently represent a hydrogen atom or a methyl group and preferably represent hydrogen atoms.

L¹³, L¹⁴, L¹⁵, and L¹⁶ are respectively synonymous with L¹, L², L³, and L⁴ of compounds represented by Formula (1), and the preferred ranges are also the same.

The compound represented by Formula (1) is preferably a compound represented by Formula (4):

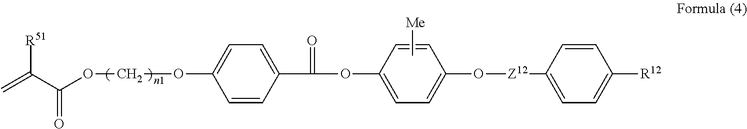

where,
n1 represents an integer of 3 to 6;
R¹¹ represents a hydrogen atom or a methyl group;
Z¹² represents —CO— or —CO—CH═CH—; and
R¹² represents a hydrogen atom, a linear alkyl group having 1 to 4 carbon atoms, a methoxy group, an ethoxy group, or a phenyl group.

n1 represents an integer of 3 to 6 and is preferably 3 or 4.

Z¹² represents —CO— or —CO—CH═CH— and preferably represents —CO—.

R¹² represents a hydrogen atom, a linear alkyl group having 1 to 4 carbon atoms, a methoxy group, an ethoxy group, or a phenyl group, preferably a methyl group, an ethyl group, a propyl group, a methoxy group, an ethoxy group, or a phenyl group, and more preferably a methyl group, an ethyl group, a methoxy group, an ethoxy group, or a phenyl group.

The compound represented by Formula (2) is preferably a compound represented by Formula (5):

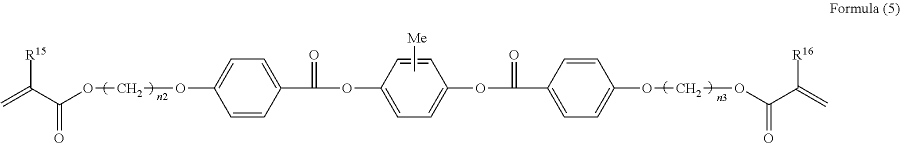

where, n2 and n3 each independently represent an integer of 3 to 6; and
R¹⁵ and R¹⁶ each independently represent a hydrogen atom or a methyl group.

In Formula (5), n2 and n3 each independently represent an integer of 3 to 6 and preferably 4.

In Formula (5), R¹⁵ and R¹⁶ each independently represent a hydrogen atom or a methyl group and preferably a hydrogen atom.

The compound represented by Formula (3) is preferably a compound represented by Formula (6):

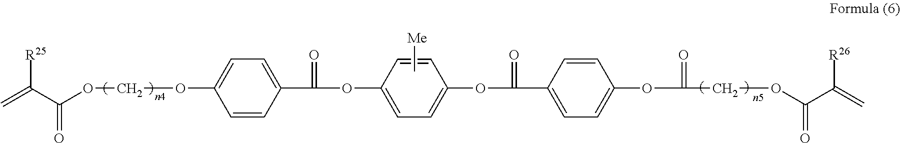

where, n4 and n5 each independently represent an integer of 3 to 6; and
R²⁵ and R²⁶ each independently represent a hydrogen atom or a methyl group.

In Formula (6), n4 and n5 each independently represent an integer of 3 to 6 and preferably 4.

In Formula (6), R²⁵ and R²⁶ each independently represent a hydrogen atom or a methyl group and preferably a hydrogen atom.

Examples of the compound represented by Formula (1) include, but not limited to, the followings:

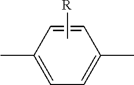

represents

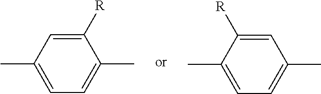

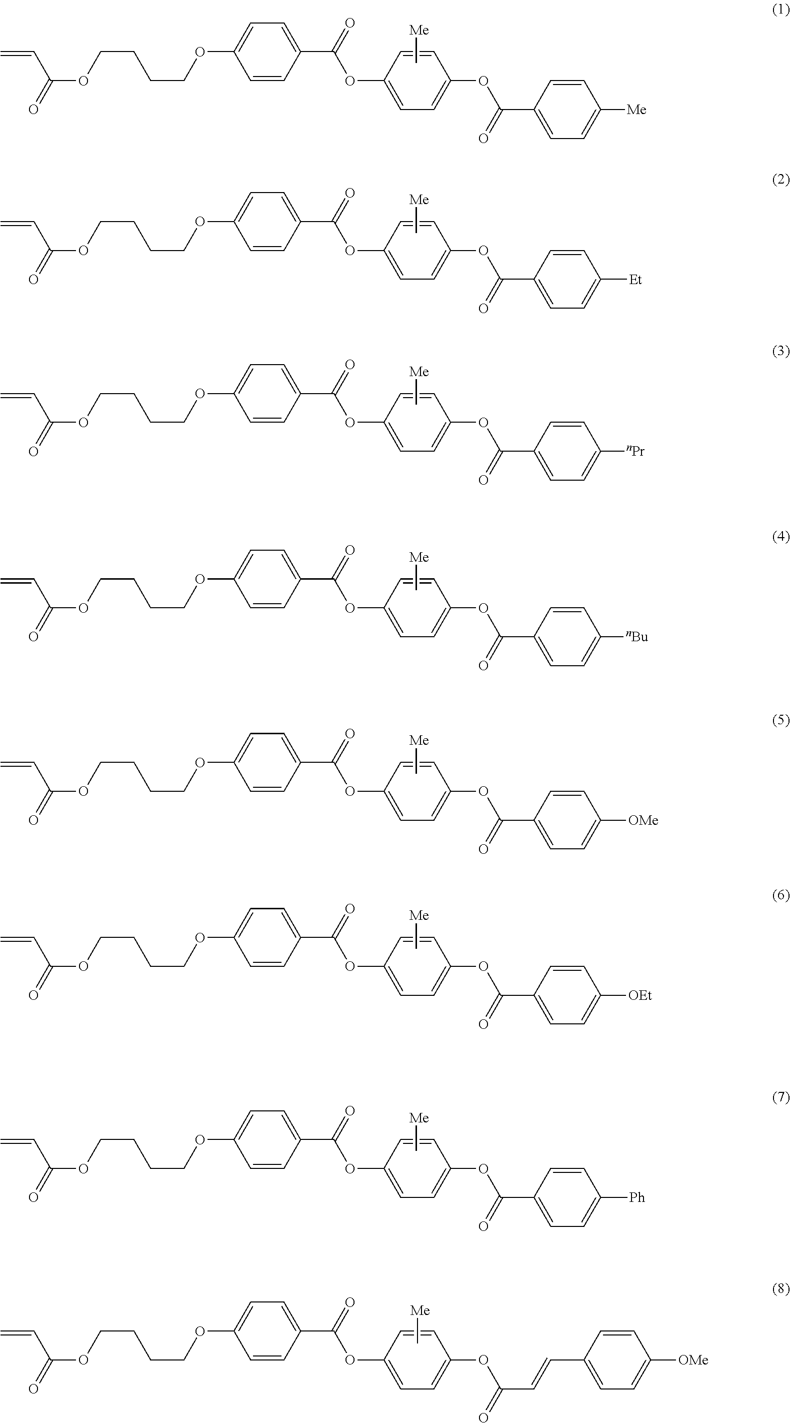

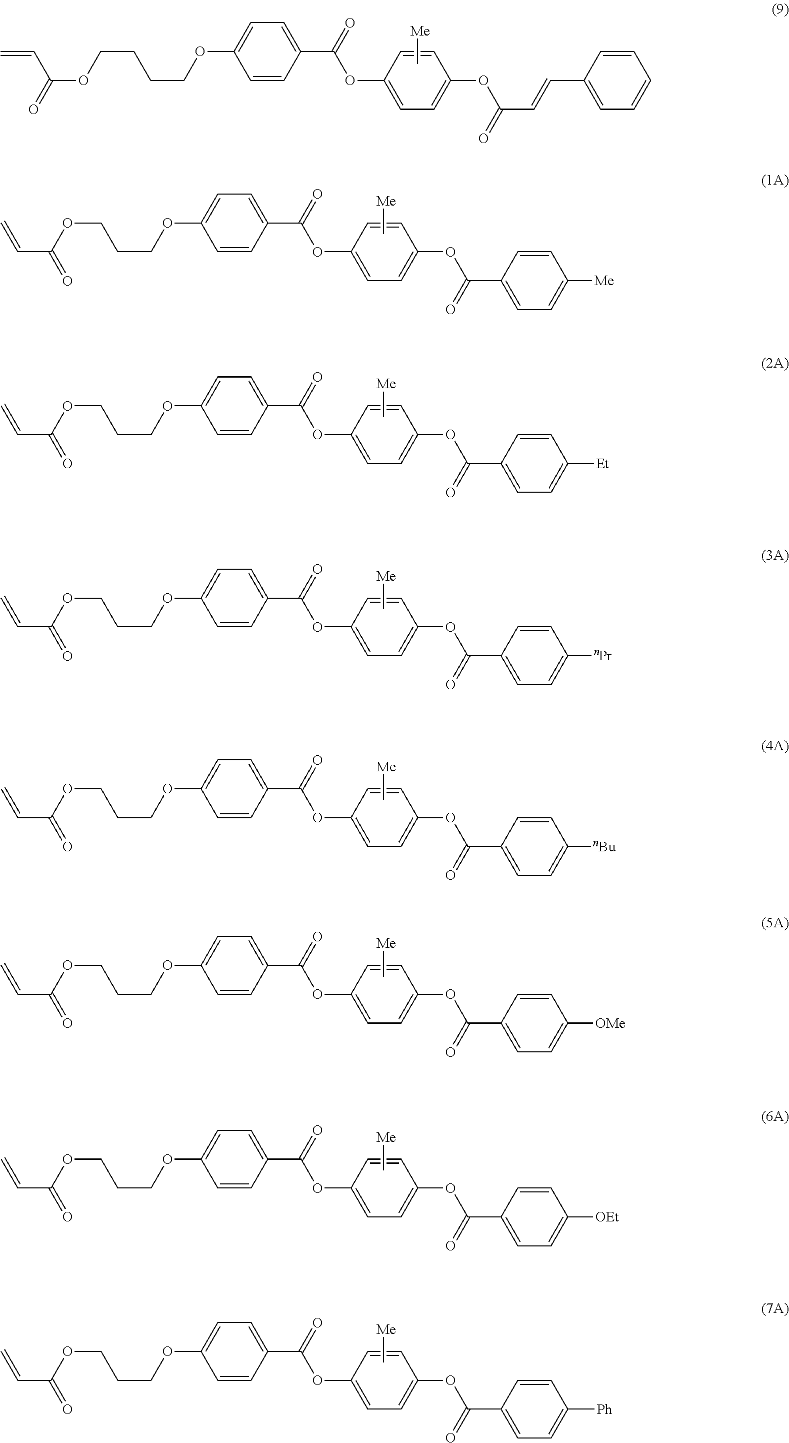

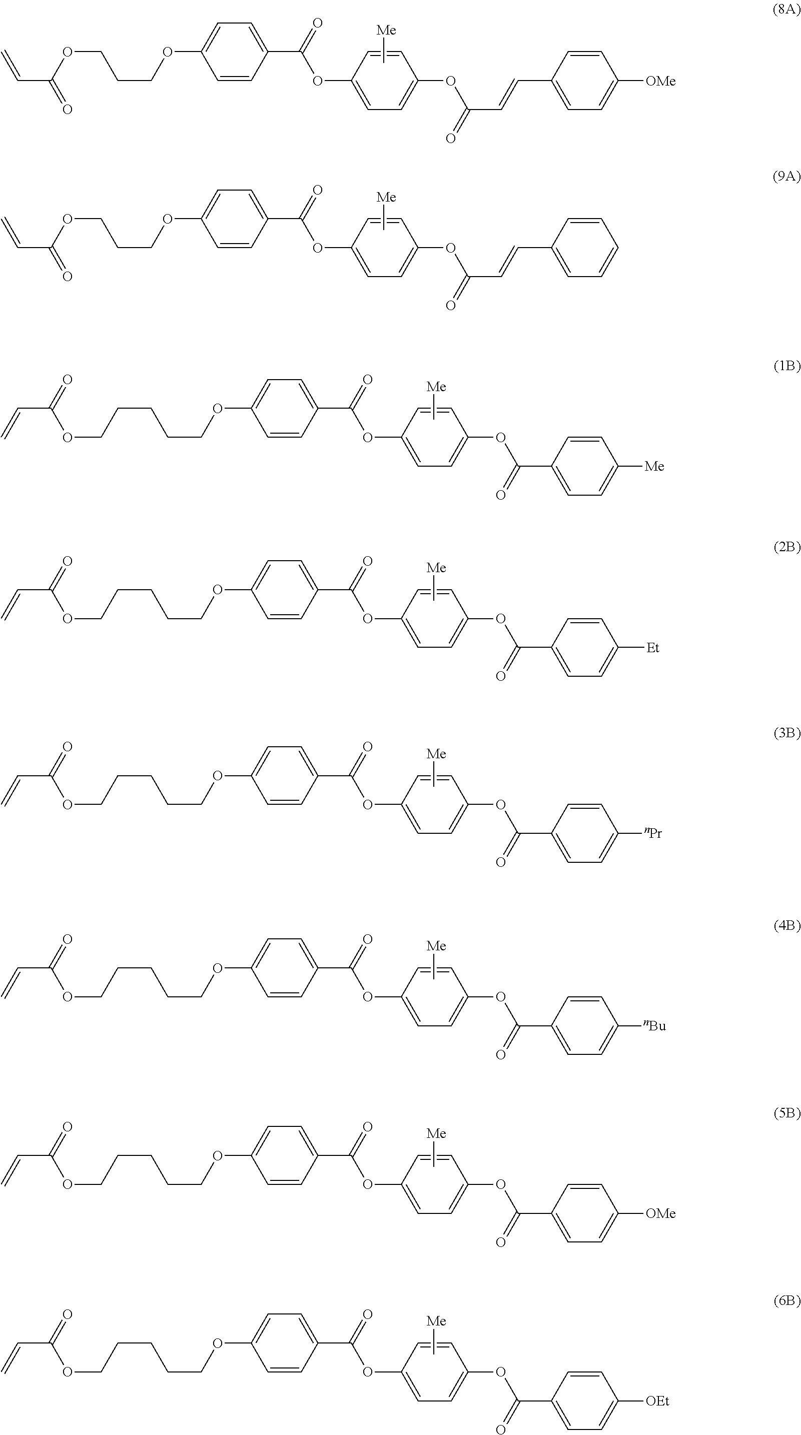

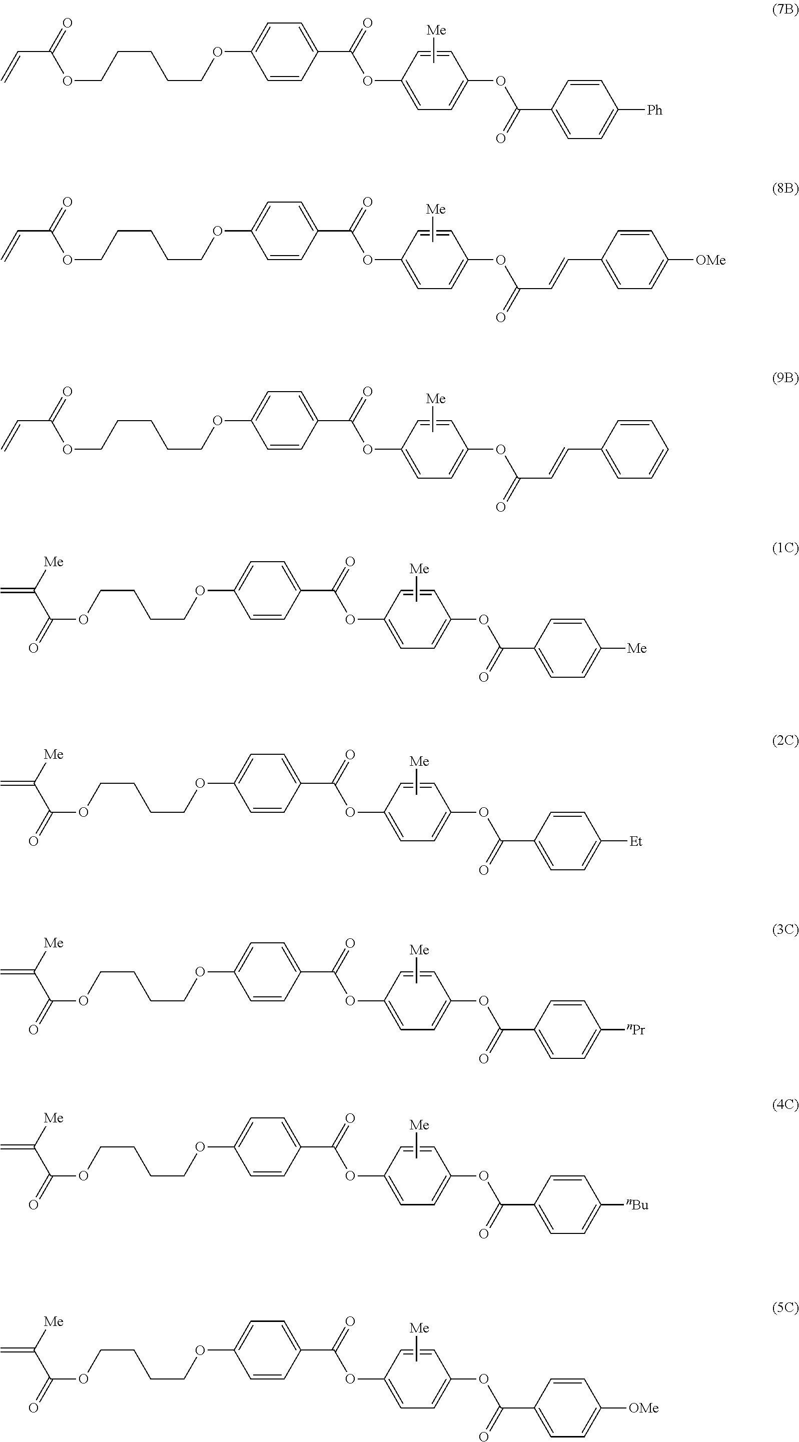

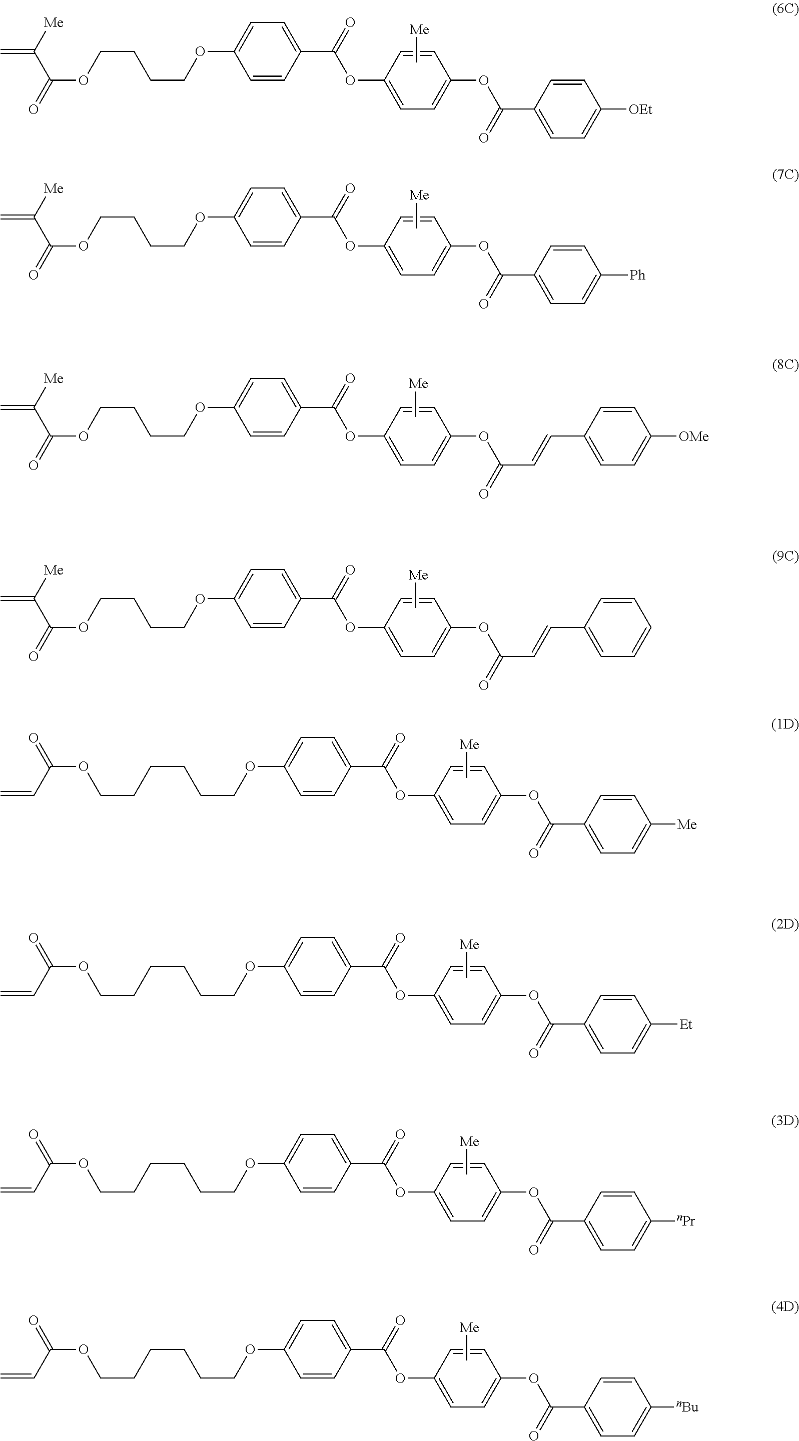

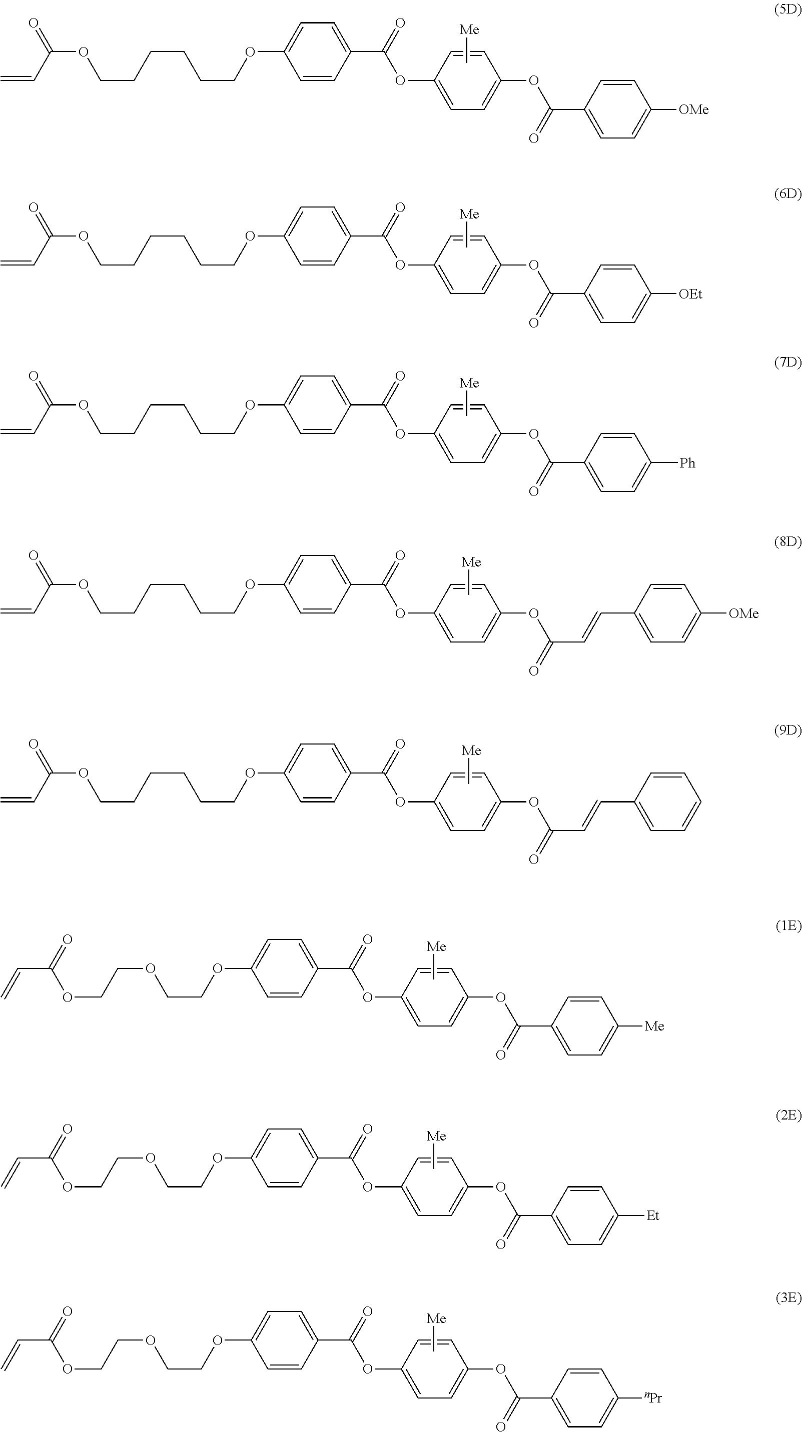

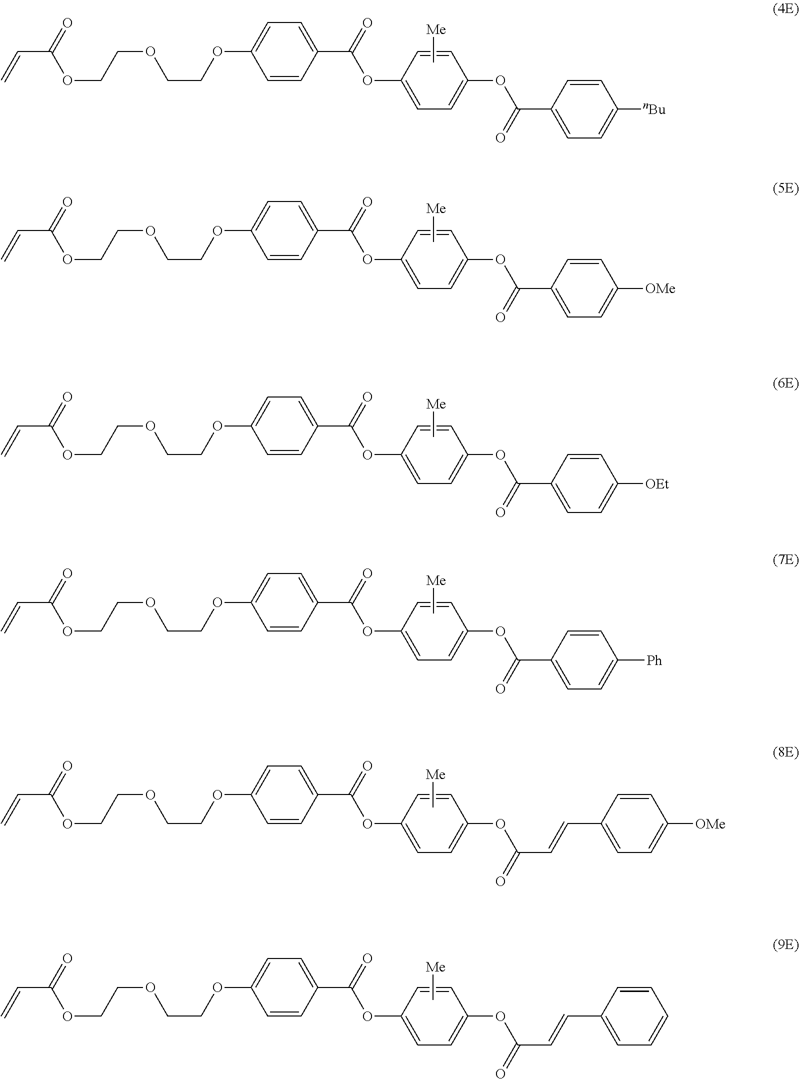

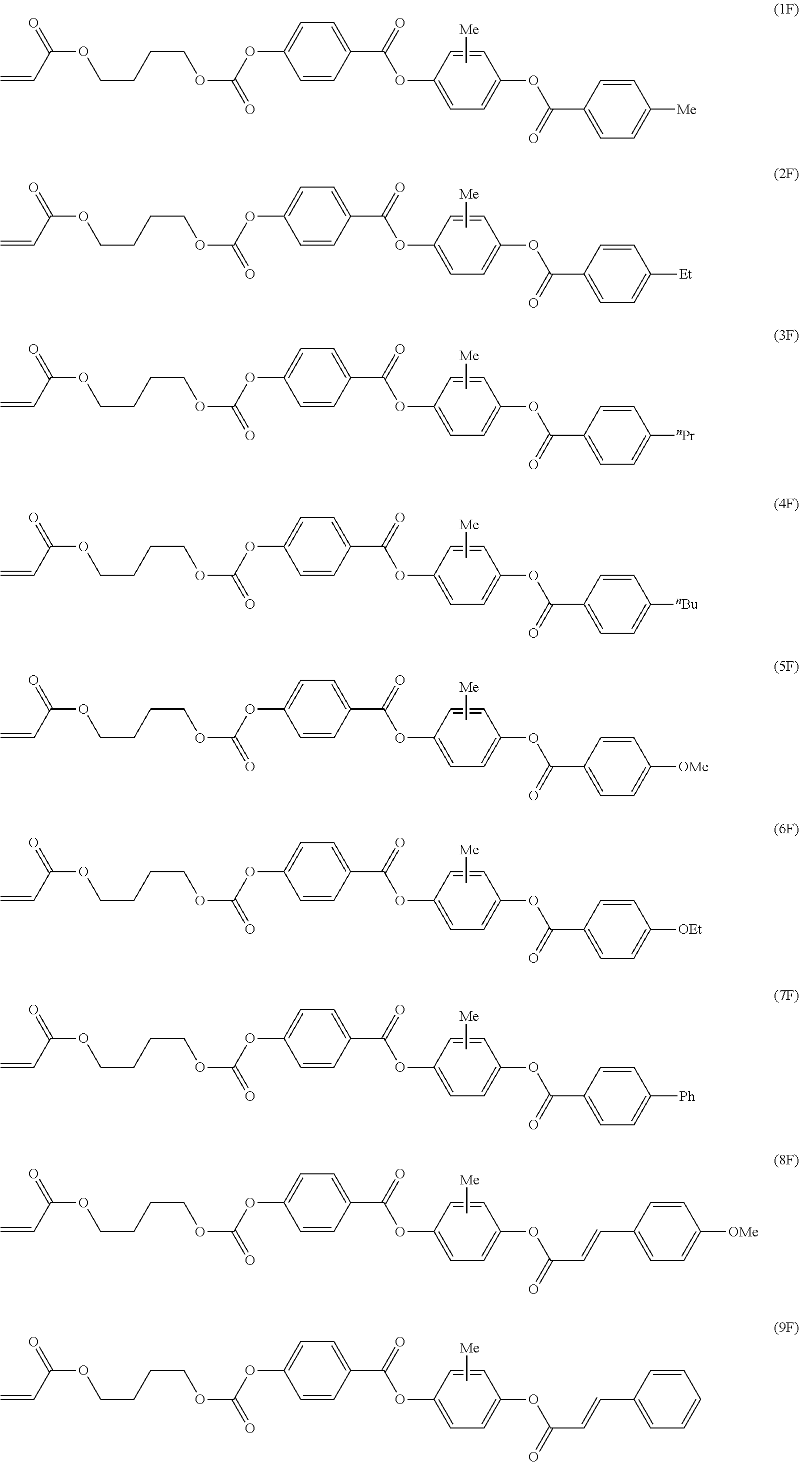

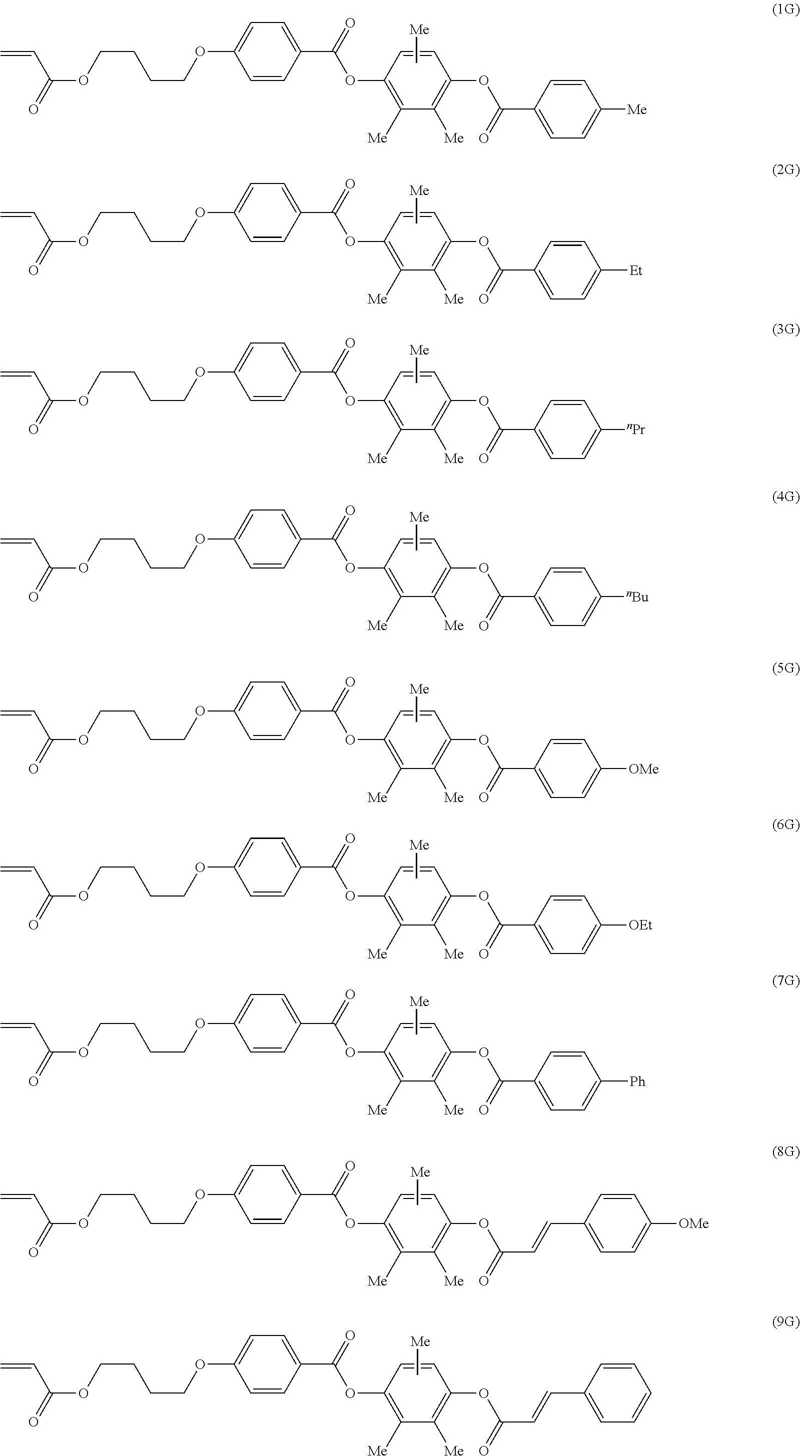

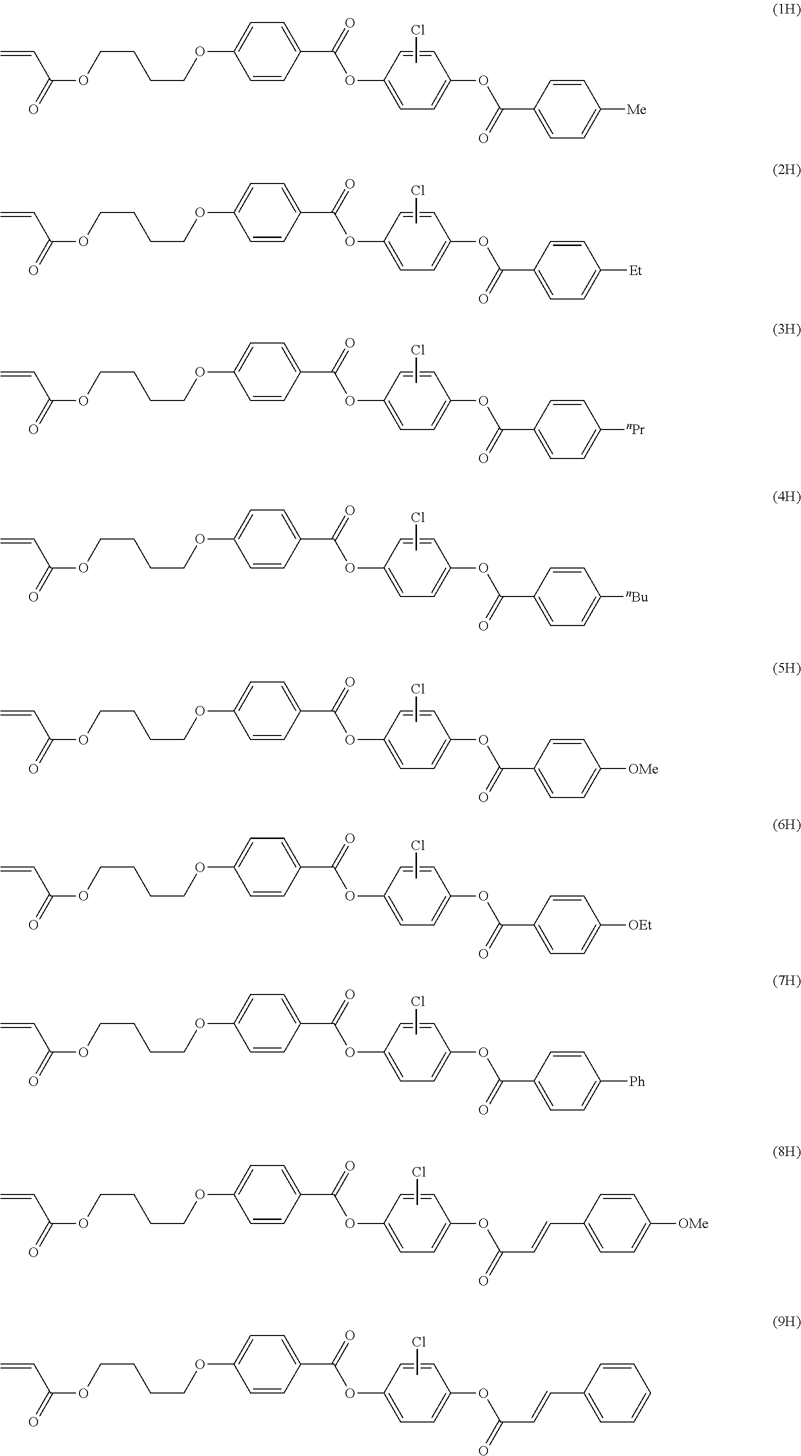

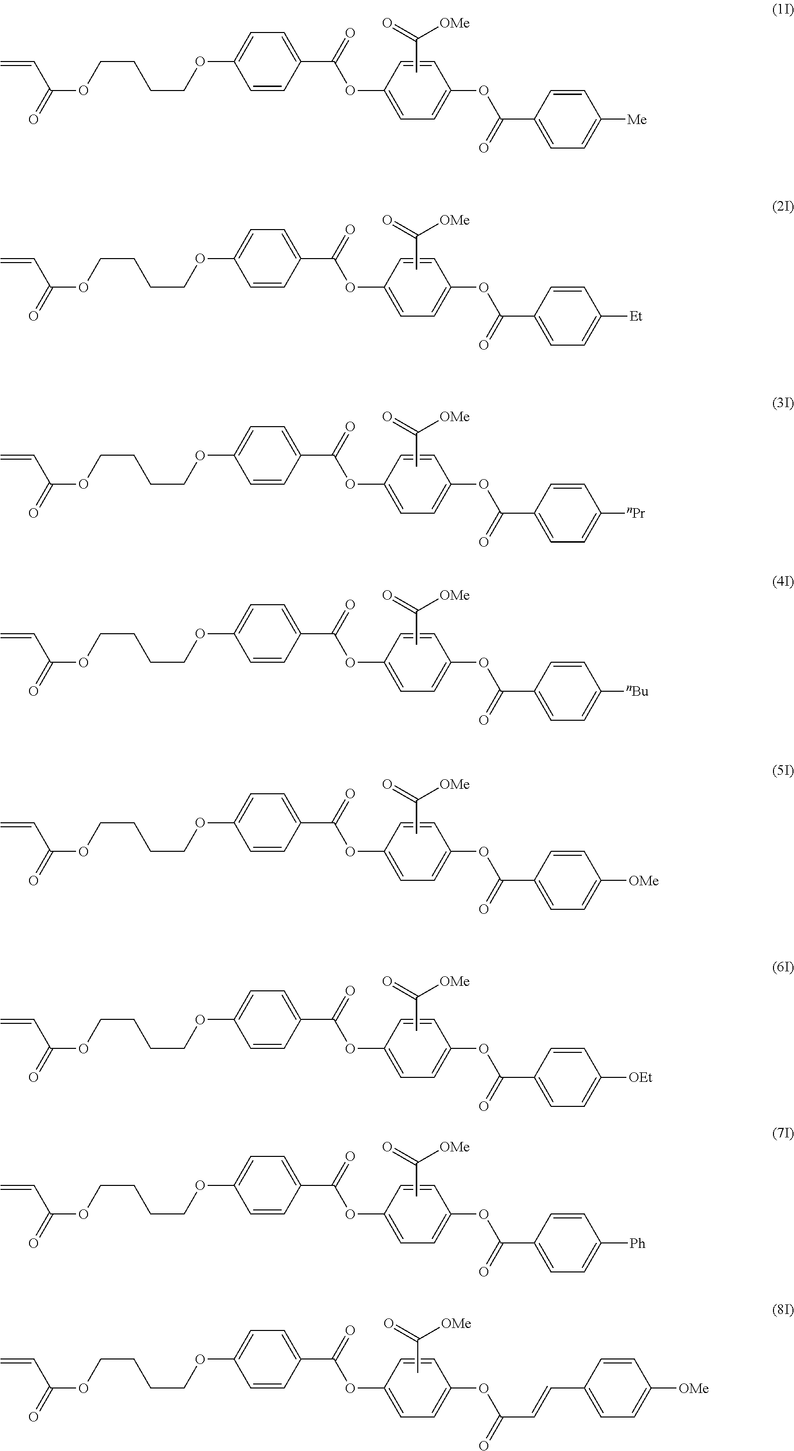

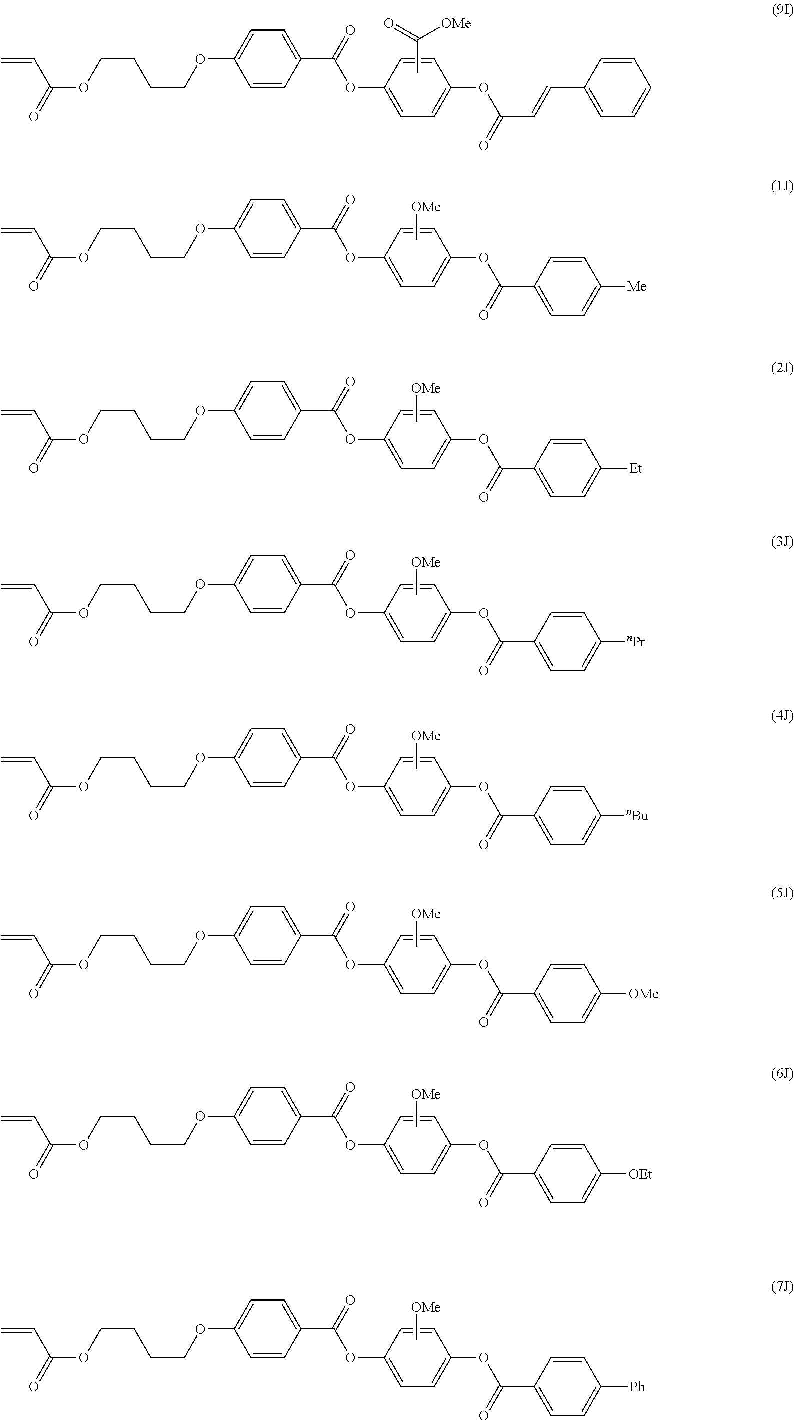

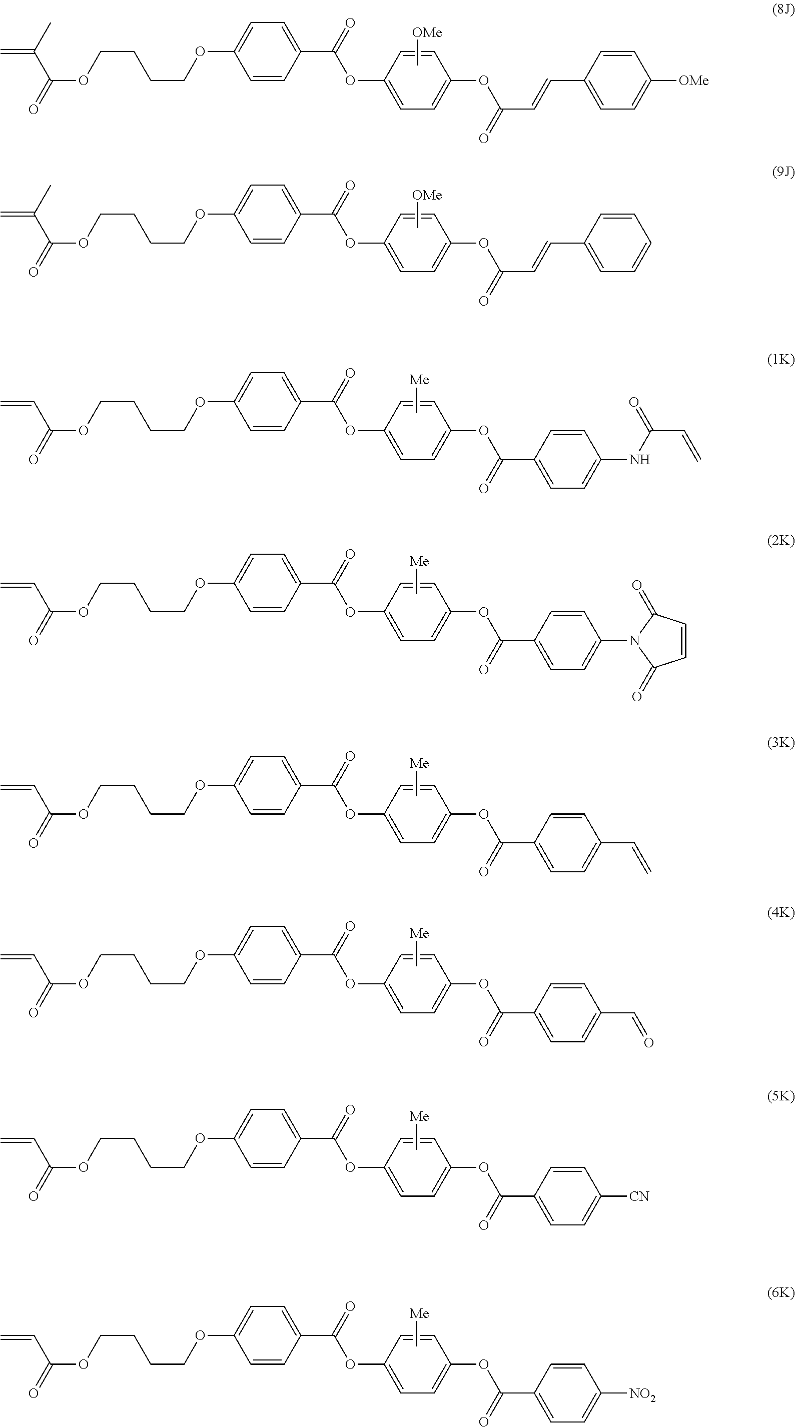

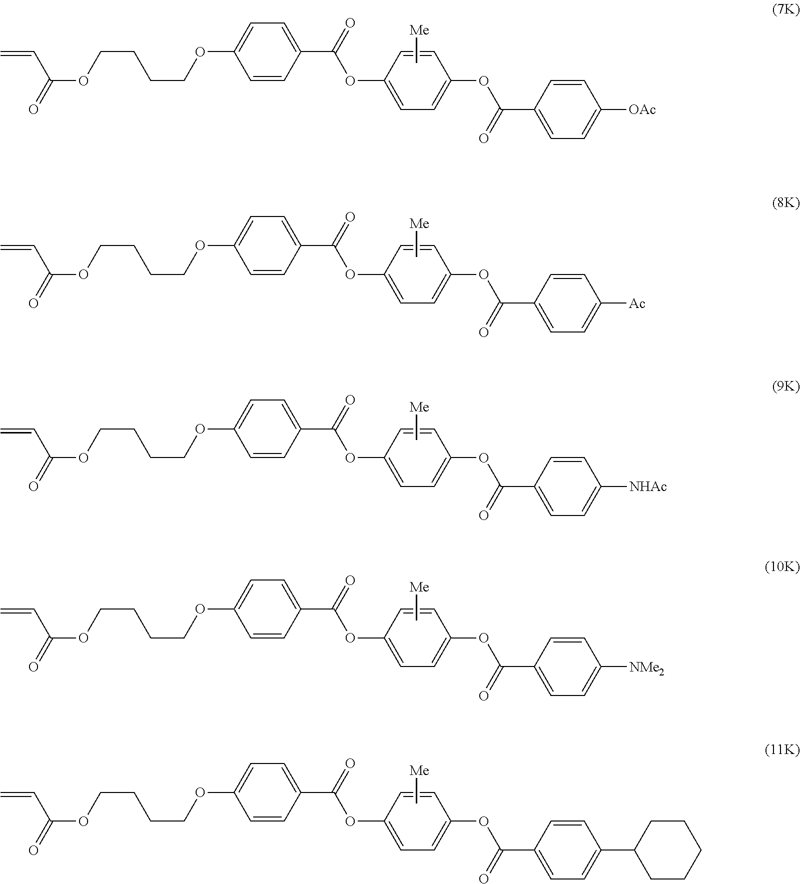

Non-limiting examples of the liquid crystal compound represented by Formula (2) and the compound represented by Formula (3) are as follows:

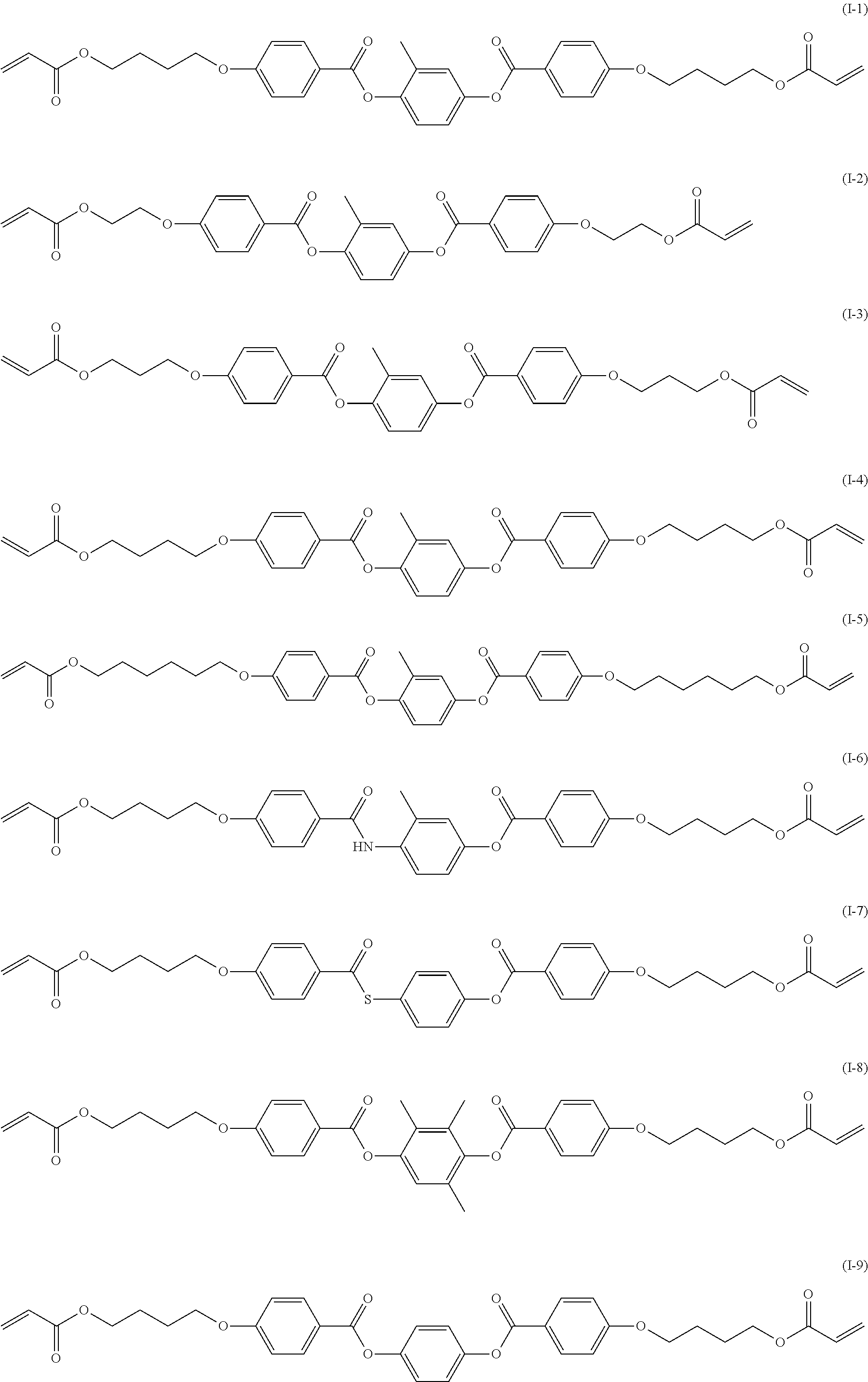

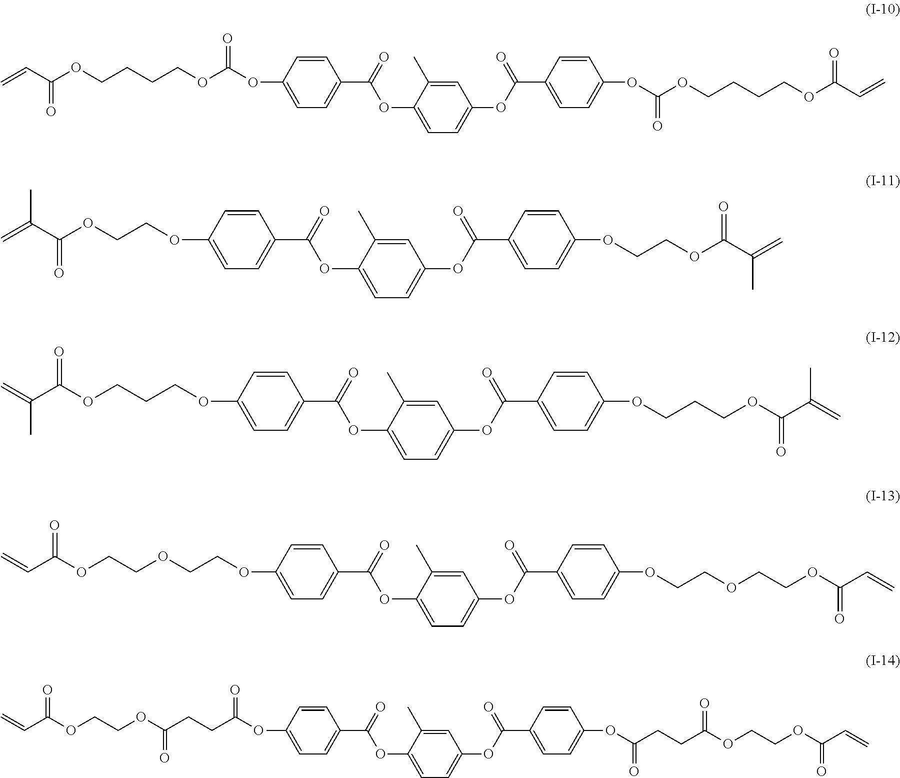

The compound represented by Formula (1) may be produced by any method and can be produced in accordance with, for example, the method described in National Publication of International Patent Application No. 2002-536529 or the method described in Molecular Crystals and Liquid Crystals, (2010), 530, 169-174.

The liquid crystal compound represented by Formula (2) and the liquid crystal compound represented by Formula (3) may be produced by any method and can be produced in accordance with, for example, the method described in Japanese Patent Laid-Open No. 2009-184975.

The optically anisotropic layer according to the present invention preferably comprises a liquid crystal compound represented by Formula (1) and a liquid crystal compound represented by Formula (2). In such a case, the mixing ratio of the liquid crystal compound represented by Formula (1) to the liquid crystal compound represented by Formula (2) is preferably 80:20 to 90:10 and more preferably 80:20 to 85:15.

A mixture a liquid crystal compound represented by Formula (2) and a liquid crystal compound represented by Formula (3) is also preferred. In such a case, the mixing ratio of the liquid crystal compound represented by Formula (2) to the liquid crystal compound represented by Formula (3) is preferably 80:20 to 90:10 and more preferably 80:20 to 85:15.

Meanwhile, examples of the discotic liquid crystal compound contained in the optically anisotropic layer according to the present invention include benzene derivatives (described in a research report by C. Destrade, et al., Mol. Cryst., vol. 71, p. 111 (1981)), truxene derivatives (described in research reports by C. Destrade, et al., Mol. Cryst., vol. 122, p. 141 (1985) and Physics lett., A, vol. 78, p. 82 (1990)), cyclohexane derivatives (described in a research report by B. Kohne, et al., Angew. Chem., vol. 96, p. 70 (1984)), and aza-crown or phenylacetylene macrocycles (described in a research report by J. M. Lehn, et al., J. Chem. Commun., p. 1794 (1985) and a research report by J. Zhang, et al., J. Am. Chem. Soc., vol. 116, p. 2655 (1994)).

More specifically, examples of the discotic liquid crystal compound include the compounds described in paragraphs [0021] to [0122] of Japanese Patent Laid-Open No. 2007-108732 and the compounds described in paragraphs [0013] to [0108] of Japanese Patent Laid-Open No. 2010-244038 can be used. These contents are incorporated herein by reference.

A liquid crystal compound having two or more reactive groups having different polymerization conditions is also preferred. In such a case, a retardation layer containing a polymer having an unreacted reactive group can be produced by polymerizing only one type of reactive groups by controlling the polymerization condition. The polymerization condition to be employed may be the wavelength region of ionizing radiation for polymerization fixation or a difference in polymerization mechanism and is preferably a combination of a radical reactive group and a cationic reactive group that can be controlled by the type of an initiator. A combination of an acrylic group and/or a methacrylic group as the radical reactive group and a vinyl ether group, an oxetane group, and/or an epoxy group as the cationic reactive group, which can readily control the reactivity, is particularly preferred.

The liquid crystal composition used in the present invention may contain any additive.

In the present invention, for example, a vertical alignment agent can be used. The amount of the vertical alignment agent is preferably 0.1 to 3 parts by mass based on the total mass, 100 parts by mass, of the liquid crystal compound. The liquid crystal compound may contain a single vertical alignment agent or two or more vertical alignment agents. In the case of containing two or more vertical alignment agents, the total mass of the vertical alignment agents is preferably within the above-mentioned range.

The vertical alignment agent is preferably a pyridinium compound or an onium compound. These compounds function as vertical alignment agents that facilitate the homeotropic alignment of the liquid crystal compound at the interface of the alignment film, and also can improve the adhesiveness of the interface between the alignment film and the optically anisotropic layer containing the liquid crystal compound in a fixed alignment state. The optically anisotropic layer containing the liquid crystal compound in a fixed alignment state may contain an air interface alignment control agent (e.g., copolymer including a repeating unit having a fluoroaliphatic group) controlling the alignment at the air interface, as necessary.

The pyridinium salt is preferably a compound represented by Formula (I):

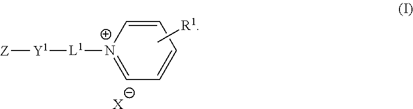

In Formula (I), L¹ represents a bivalent linker that is preferably a combination of an alkylene group with —O—, —S—, —CO—, —SO₂—, —NR^{a}— (wherein, R^{a} is an alkyl group having 1 to 5 carbon atoms or a hydrogen atom), an alkenylene group, an alkynylene group, or an arylene group and preferably has 1 to 20 carbon atoms. The alkylene group may be linear or branched.

In Formula (I), R¹ is a hydrogen atom, an unsubstituted amino group, or a substituted amino group having a substituent of 1 to 20 carbon atoms. When R¹ is a substituted amino group, the amino group preferably has an aliphatic substituent group. Examples of the aliphatic group include alkyl groups, substituted alkyl groups, alkenyl groups, substituted alkenyl groups, alkynyl groups, and substituted alkynyl groups. When R¹ represents a di-substituted amino group, two aliphatic groups are optionally bonded to each other to form a nitrogen-containing heterocycle. The nitrogen-containing heterocycle formed on this occasion is preferably a 5- or 6-membered ring. R¹ is preferably a hydrogen atom, an unsubstituted amino group, or a substituted amino group having 1 to 20 carbon atoms, more preferably a hydrogen atom, an unsubstituted amino group, or a substituted amino group having 2 to 12 carbon atoms, and most preferably a hydrogen atom, an unsubstituted amino group, or a substituted amino group having 2 to 8 carbon atoms. When R¹ is an amino group, the amino group is preferably introduced at position 4 of the pyridinium ring.

In Formula (I), X is an anion. Examples of the anion include halides (e.g., fluoride, chloride, bromide, and iodide), sulfonates (e.g., methanesulfonate, trifluoromethanesulfonate, methylsulfate, p-toluenesulfonate, p-chlorobenzenesulfonate, 1,3-benzenedisulfonate, 1,5-naphthalenedisulfonate, and 2,6-naphthalenedisulfonate), sulfates, carbonates, nitrate, thiocyanate, perchlorate, tetrafluoroborate, picrate, acetate, formate, trifluoroacetate, phosphates (e.g., hexafluorophosphate), and hydroxy. X is preferably a halide, a sulfonate, or hydroxy.

In Formula (I), Y¹ is a bivalent linker having 1 to 30 carbon atoms and a 5- or 6-membered ring as a partial structure. The cyclic partial structure in the linker represented by Y¹ is preferably a cyclohexyl ring, an aromatic ring, or a heterocycle. Examples of the aromatic ring include benzene, indene, naphthalene, fluorene, phenanthrene, anthracene, biphenyl, and pyrene rings. Particularly preferred are benzene, biphenyl, and naphthalene rings. The heterocycle preferably has a nitrogen atom, an oxygen atom, or a sulfur atom as a heteroatom. Examples of the heterocycle include furan, thiophene, pyrrole, pyrroline, pyrrolidine, oxazole, isoxazole, thiazole, isothiazole, imidazole, imidazoline, imidazolidine, pyrazole, pyrazoline, pyrazolidine, triazole, furazan, tetrazole, pyran, dioxane, dithiane, thiin, pyridine, piperidine, oxazine, morpholine, thiazine, pyridazine, pyrimidine, pyrazine, piperazine, and triazine rings. The heterocycle is preferably a 6-membered ring. The bivalent linker having a 5- or 6-membered ring as a partial structure represented by Y¹ may optionally have a substituent.

In Formula (I), Z is preferably a halogen-substituted phenyl group, a nitro-substituted phenyl group, a cyano-substituted phenyl group, a phenyl group having an alkyl substituent group of 1 to 10 carbon atoms, a phenyl group having an alkoxy substituent group of 2 to 10 carbon atoms, an alkyl group having 1 to 12 carbon atoms, an alkynyl group having 2 to 20 carbon atoms, an alkoxy group having 1 to 12 carbon atoms, an alkoxycarbonyl group having 2 to 13 carbon atoms, an aryloxycarbonyl group having 7 to 26 carbon atoms, or an arylcarbonyloxy group having 7 to 26 carbon atoms, and preferred are a cyano-substituted phenyl group, a halogen-substituted phenyl group, a phenyl group having an alkyl substituent group of 1 to 10 carbon atoms, a phenyl group having an alkoxy substituent group of 2 to 10 carbon atoms, an aryloxycarbonyl group having 7 to 26 carbon atoms, and an arylcarbonyloxy group having 7 to 26 carbon atoms.

The group represented by Z may further has a substituent, and examples of the substituent include halogen atoms (e.g., fluorine, chlorine, bromine, and iodine atoms), a cyano group, a nitro group, alkyl groups having 1 to 16 carbon atoms, alkenyl groups having 1 to 16 carbon atoms, alkynyl groups having 1 to 16 carbon atoms, halogen-substituted alkyl groups having 1 to 16 carbon atoms, alkoxy groups having 1 to 16 carbon atoms, acyl groups having 2 to 16 carbon atoms, alkylthio groups having 1 to 16 carbon atoms, acyloxy groups having 2 to 16 carbon atoms, alkoxycarbonyl groups having 2 to 16 carbon atoms, carbamoyl groups, alkyl-substituted carbamoyl groups having 2 to 16 carbon atoms, and acylamino groups having 2 to 16 carbon atoms.

The pyridinium compound used in the present invention is preferably a pyridinium compound represented by Formula (Ia):

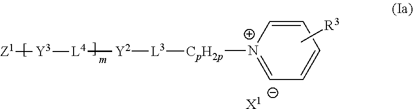

In Formula (Ia), L³ represents a single bond, —O—, —O—CO—, —CO—O—, —C≡C—, —CH═CH—, —CH═N—, —N═CH—, —N═N—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—, where AL represents an alkylene group having 1 to 10 carbon atoms. L³ is preferably a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O— and preferably a single bond or —O—.

In Formula (Ia), L⁴ represents a single bond, —O—, —O—CO—, —CO—O—, —C≡C—, —CH═CH—, —CH═N—, —N═CH—, or —N═N—.

In Formula (Ia), R³ represents a hydrogen atom, an unsubstituted amino group, or a substituted amino group having 2 to 20 carbon atoms. When R³ represents a dialkyl-substituted amino group, the two alkyl groups are optionally bonded to each other to form a nitrogen-containing heterocycle. The nitrogen-containing heterocycle formed on this occasion is preferably a 5- or 6-membered ring. R³ is more preferably a hydrogen atom, an unsubstituted amino group, or a dialkyl-substituted amino group having 2 to 12 carbon atoms and most preferably a hydrogen atom, an unsubstituted amino group, or a dialkyl-substituted amino group having 2 to 8 carbon atoms. When R³ is an amino group, the amino group is preferably introduced at position 4 of the pyridinium ring.

In Formula (Ia), Y² and Y³ each independently represent a bivalent 6-membered ring group optionally having a substituent. Examples of the 6-membered ring include alicycles, aromatic rings (benzene ring), and heterocycles. Examples of 6-membered alicycles include cyclohexane, cyclohexene, and cyclohexadiene rings. Examples of the 6-membered heterocycles include pyran, dioxane, dithiane, thiin, pyridine, piperidine, oxazine, morpholine, thiazine, pyridazine, pyrimidine, pyrazine, piperazine, and triazine rings. The 6-membered ring may optionally be condensed with another 6-membered ring or a 5-membered ring.

Examples of the substituent include halogen atoms, a cyano group, alkyl groups having 1 to 12 carbon atoms, and alkoxy groups having 1 to 12 carbon atoms. The alkyl groups and the alkoxy groups may optionally be substituted with acyl groups having 2 to 12 carbon atoms or acyloxy groups having 2 to 12 carbon atoms. The definitions of the acyl group and the acyloxy group are described below.

In Formula (Ia), X¹ represents an anion, preferably a monovalent anion. Examples of the anion include halides (e.g., fluoride, chloride, bromide, and iodide) and sulfonates (e.g., methanesulfonate, p-toluenesulfonate, and benzenesulfonate).

In Formula (Ia), Z¹ represents a hydrogen atom, a cyano group, an alkyl group having 1 to 12 carbon atoms, or an alkoxy group having 1 to 12 carbon atoms. The alkyl group and the alkoxy group may each optionally have an acyl substituent group of 2 to 12 carbon atoms or an acyloxy substituent group of 2 to 12 carbon atoms.

In Formula (Ia), m represents 1 or 2. When m is 2, two L⁴s may be different from each other, and two Y³s also may be different from each other.

When m represents 2, Z¹ is preferably a cyano group, an alkyl group having 1 to 10 carbon atoms, or an alkoxy group having 1 to 10 carbon atoms.

When m represents 1, Z¹ is preferably an alkyl group having 7 to 12 carbon atoms, an alkoxy group having 7 to 12 carbon atoms, an acyl-substituted alkyl group having 7 to 12 carbon atoms, an acyl-substituted alkoxy group having 7 to 12 carbon atoms, an acyloxy-substituted alkyl group having 7 to 12 carbon atoms, or an acyloxy-substituted alkoxy group having 7 to 12 carbon atoms.

The acyl group is represented by —CO—R, and the acyloxy group is represented by —O—CO—R. R is an aliphatic group (alkyl, substituted alkyl, alkenyl, substituted alkenyl, alkynyl, or substituted alkynyl group) or an aromatic group (aryl or substituted aryl group). R is preferably an aliphatic group and more preferably an alkyl group or an alkenyl group.

In Formula (Ia), p represents an integer of 1 to 10. CₚH₂ₚ represents a chain alkylene group optionally having a branched structure. CₚH₂ₚ is preferably a linear alkylene group. p is more preferably 1 or 2.

Examples of the compound represented by Formula (I) and/or Formula (Ia) are described in paragraphs [0049] to [0052] of Japanese Patent Laid-Open No. 2007-093864, the entirety of which is incorporated herein by reference. The onium compound is described in, for example, paragraphs [0027] to [0058] of Japanese Patent Laid-Open No. 2012-208397, the entirety of which is incorporated herein by reference.

The liquid crystal composition used in the present invention can also contain a binder. The amount of the binder is preferably 0.5 to 20 parts by mass based on the total mass, 100 parts by mass, of the liquid crystal compound. The liquid crystal compound may contain a single binder or two or more binders. In the case of containing two or more binders, the total mass of the binders is preferably within the above-mentioned range.

Examples of the binder include acrylic binders, which are represented by the following formula.

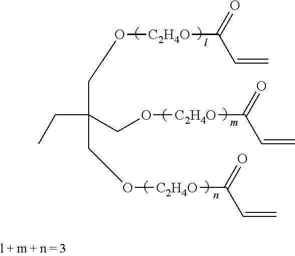

Acrylic binders can increase the NI point and is therefore effective for increasing the order parameter.

The liquid crystal composition in the present invention can contain a binding and adherence agent, a leveling agent, a polymerization initiator, a sensitizer, and a binder, in addition to the vertical alignment agent.

The liquid crystal composition used in the present invention usually contains a solvent. Examples of the solvent include amides (e.g., N,N-dimethylformamide), sulfoxides (e.g., dimethylsulfoxide), heterocyclic compounds (e.g., pyridine), hydrocarbons (e.g., benzene, hexane, and cyclohexane), alkyl halides (e.g., chloroform and dichloromethane), esters (e.g., methyl acetate and butyl acetate), ketones (e.g., acetone and methyl ethyl ketone), and ethers (e.g., tetrahydrofuran and 1,2-dimethoxyethane). Hydrocarbons and/or ketones are preferred.

The liquid crystal compound may contain a single solvent or two or more solvents. In the present invention, the solid content in the liquid crystal composition is preferably adjusted to 20% to 50% by mass.

### Method of Forming Optically Anisotropic Layer

A method of forming an optically anisotropic layer will now be described. In an example, an optically anisotropic layer is formed by coating a liquid crystal composition containing liquid crystal compounds in a transparent support or an alignment film described below, aligning the liquid crystal compound in a predetermined alignment state by maintaining the temperature at which the liquid crystal compound forms a liquid crystal phase, and fixing the alignment state of the liquid crystal compound through light irradiation. More preferably, a liquid crystal composition containing liquid crystal compounds is applied in a transparent support or on an alignment film described below, the liquid crystal compound is aligned in a predetermined alignment state by maintaining the temperature at which the liquid crystal compound forms a liquid crystal phase, and the alignment state of the liquid crystal compound is fixed by UV ray irradiation at a predetermined temperature, preferably at 30° C. to 60° C.

The liquid crystal composition described above is applied in a transparent support or on an alignment film (usually, the surface). The application may be performed by a known process such as curtain coating, dip coating, spin coating, print coating, spray coating, slot coating, roll coating, slide coating, blade coating, gravure coating, or wire-bar coating.

After the application of the liquid crystal composition, the liquid crystal compound is maintained at a temperature to form a liquid crystal phase, resulting in a desired alignment state of the liquid crystal molecules. During such a process, the liquid crystal composition is preferably heated. The heating temperature is preferably 50° C. to 120° C. and more preferably 70° C. to 100° C. The heating time is preferably about 60 to 300 seconds and more preferably about 90 to 300 seconds.

The liquid crystal molecules in a desired alignment state is then cured by polymerization to fix the alignment state to form an optically anisotropic layer. The light for irradiation can be X rays, electron rays, ultraviolet rays, visible rays, or infrared rays (heat rays). In particular, ultraviolet (UV) rays are preferred. The light source is preferably a low-pressure mercury lamp (a bactericidal lamp, fluorescent chemical lamp, or black light), a high-pressure discharge lamp (a high-pressure mercury lamp or metal halide lamp), or a short arc discharge lamp (an extra-high pressure mercury lamp, xenon lamp, or mercury/xenon lamp). The exposure is preferably about 50 to 6000 mJ/cm² and more preferably about 100 to 2000 mJ/cm². In order to control the alignment within a short period of time, the light is preferably irradiated while the liquid crystal compound is being heated. In such a case, the heating temperature is preferably 30° C. to 60° C. and more preferably 40° C. to 50° C.

The optically anisotropic layer prepared by, for example, the above-described method preferably has a retardation in the thickness direction Rth(550) of −200 to −100 nm, more preferably −180 to −120 nm, and most preferably −160 to −140 nm at a wavelength of 550 nm.

The optically anisotropic layer in the present invention preferably has a retardation in-plane Re(550) of −1.0 to +1.0 nm, more preferably −0.5 to +0.5 nm, and most preferably −0.1 to +0.1 nm at a wavelength of 550 nm.

In the present invention, the optically anisotropic layer preferably has a thickness of 0.1 to 20 μm and more preferably 0.2 to 5 μm. From the viewpoint of uniform alignment of the liquid crystal compound, the thickness of the optically anisotropic layer is preferably 1.0 μm or more and more preferably 1.0 to 2.0 μm.

### <<Transparent Support>>

The transparent support used in the present invention is preferably a transparent polymer film having a light transmittance of 80% or more. Examples of the polymer film that can be used as the transparent support include polymer films formed of cellulose esters (cellulose acylates such as cellulose acetate, cellulose diacetate, and cellulose triacetate), cyclic polyolefin polymers, cyclic polyolefin copolymers, norbornene polymers, poly(methyl methacrylates), and acrylic polymers. Preferred are cellulose acylate-based films, cyclic olefin polymer films, and acrylic polymer films.

Commercially available polymer films may also be used, for example, norbornene polymer films, such as ARTON (registered trademark), ZEONEX (registered trademark), and APEL (registered trademark). Cellulose ester films are also preferred, and films formed of lower fatty acid esters of cellulose are more preferred. The lower fatty acid refers to a fatty acid having 6 or less carbon atoms.

In the present invention, a transparent support containing cellulose acylate including an acyl group having an aromatic group is particularly preferred. A preferred acyl group having an aromatic group is represented by Formula (I):

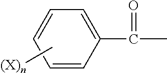

where, X represents a hydrogen atom or a substituent; and n represents an integer of 0 to 5. When n represents an integer of 2 or more, Xs may optionally be bonded to each other to form a condensed polycycle.)

The substituent is preferably a halogen atom, a cyano group, an alkyl group, an alkoxy group, an aryl group, an aryloxy group, an acyl group, a carbonamido group, a sulfonamido group, or an ureido group, more preferably a halogen atom, a cyano group, an alkyl group, an alkoxy group, an aryloxy group, an acyl group, or a carbonamido group, more preferably a halogen atom, a cyano group, an alkyl group, an alkoxy group, or an aryloxy group, and most preferably a halogen atom, an alkyl group, or an alkoxy group.

In Formula (I), the number (n) of the substituent X on the aromatic ring is 0 to 5, preferably 1 to 3, and most preferably 1 or 2.

The method of producing such a cellulose acylate is described in paragraph [0015] of Japanese Patent Laid-Open No. 2002-322201, the entirety of which is incorporated herein by reference.

Examples of the acyl group having an aromatic group are described in paragraphs [0017] to [0020] of Japanese Patent Laid-Open No. 2002-322201, the entirety of which is incorporated herein by reference.

The cellulose acylate-based film used in the present invention preferably has a degree of acyl substitution of 2.0 to 3.0 and more preferably 2.3 to 2.7. Such a structure is favorable for the advantageous effect of the present invention. The cellulose acylate-based film used in the present invention may be a laminate composed of two, three, four, or more layers prepared by, for example, co-casting. In such a case, the degree of acyl substitution is the average of degrees of acyl substitution of individual layers.

The degree of substitution is determined by measurement and calculation of the degree of acetylation in accordance with ASTM: D817-91 (Standard Test Methods of Testing Cellulose Acetate Propionate and Cellulose Acetate Butyrate).

The cellulose acetate preferably has a viscosity-average degree of polymerization (DP) of 250 or more and more preferably 290 or more. The cellulose acetate preferably has a narrow molecular weight distribution defined by Mw/Mn (Mw: mass-average molecular weight, Mn: number-average molecular weight) determined by gel permeation chromatography.

Specifically, the value of Mw/Mn is preferably 1.0 to 4.0, more preferably 1.0 to 1.65, and most preferably 1.0 to 1.6.

### <<Additive>>

The cellulose acylate-based film used in the present invention may further contain, for example, a polycondensation ester, a sugar ester, a retardation-developing agent, an antioxidant, a peeling accelerator, microparticles, a thermal degradation inhibitor, and an ultraviolet absorber, within the scope of the present invention.

Examples of the polycondensation ester are described in paragraphs [0034] to [0049] of Japanese Patent Laid-Open No. 2012-226276, the entirety of which is incorporated herein by reference.

Examples of the sugar ester are described in paragraphs [0050] to [0080] of Japanese Patent Laid-Open No. 2012-226276, the entirety of which is incorporated herein by reference. The addition of these compounds facilitates the adjustment of moisture permeability or water content due to their hydrophobicity and the adjustment of mechanical properties due to their plasticity. In the present invention, particularly preferred is a sugar ester comprising 1 to 12 pyranose or furanose structures each having at least one aromatic esterified hydroxyl group.

The retardation-developing agent is preferably a nitrogen-containing aromatic compound. Examples of the retardation-developing agent are described in paragraphs [0081] to [0109] of Japanese Patent Laid-Open No. 2012-226276, the entirety of which is incorporated herein by reference.

Examples of other additives are described in paragraphs [0109] to [0112] of Japanese Patent Laid-Open No. 2012-226276, the entirety of which is incorporated herein by reference. The compounds described in International Publication No. W02008-126535 can be also employed.

Known polymers that readily express birefringence, such as polycarbonates and polysulfones, can be also used as a transparent support in the present invention by controlling the expression of birefringence through modification of the molecules as described in International Publication No. WO00/26705.

The transparent support preferably has a retardation in-plane Re(550) of 70 nm or less, more preferably 50 nm or less, and most preferably 10 nm or less at a wavelength of 550 nm. The lower limit is not particularly limited and is 0 nm or more.

The transparent support preferably has a retardation in the thickness direction Rth(550) of 0 to 200 nm, more preferably 0 to 50 nm, and most preferably 0 to 30 nm at a wavelength of 550 nm.

The transparent support preferably has a thickness of 20 to 60 μm, more preferably 25 to 60 μm, and most preferably 25 to 45 μm.

The support used in the present invention may be produced by the method described in an embodiment of Japanese Patent Laid-Open No. H10-45804 or in Japanese Patent Laid-Open No. 2011-127127.

### <<Alignment Film>>

The optically-compensatory film of the present invention may include an alignment film. In particular, the liquid crystal compound in the present invention is preferably vertically aligned and/or preferably aligned so as to have an order parameter of 0.55 or more after the polymerization. Such alignment can be achieved by, for example, disposing an alignment film between the optically anisotropic layer and the transparent support. The alignment film is usually a polyvinyl alcohol or modified polyvinyl alcohol film. In the present invention, in order to utilize a more uniform alignment regulating force for improving the contrast, an alignment film containing a (meth)acrylic resin, an alignment film having a high alignment regulating force, or a photo-alignment film can be used. It is also preferred to perform at least any of hybrid uniform alignment through horizontal alignment, magnetic field alignment, oblique deposition alignment, hybrid uniform alignment through isothermal heating, alignment facilitated by a wind blow, alignment facilitated by a low polymerization temperature, and alignment facilitated by a difference in temperature. The alignment facilitated by a low polymerization temperature is more preferred.

### <<<Alignment Film Containing (Meth)Acrylic Resin>>>

The optically-compensatory film of the present invention preferably includes an alignment film containing a (meth)acrylic resin between the transparent support and the optically anisotropic layer. The alignment film is particularly preferred to be formed from a composition having a solid content of 10% to 60% by mass. The optically-compensatory film including the alignment film containing a (meth)acrylic resin can appropriately align the liquid crystal compound contained in the optically anisotropic layer. The solid content is preferably 12% to 50% by mass and more preferably 15% to 45% by mass.

After application of the alignment film composition described in detail below, the coating is preferably dried at 10° C. to 70° C., more preferably 15° C. to 60° C., more preferably 20° C. to 50° C., and most preferably 25° C. to 40° C. The drying in this range can improve the order parameter of the liquid crystal compound.

The alignment film containing a (meth)acrylic resin is preferably formed by curing a composition containing a (meth)acrylate monomer having a ratio Y (number of carbon atoms)/M (number of atoms other than carbon and hydrogen atoms) of 1.4 or more and less than 3, preferably 1.8 or more and less than 2, and more preferably 1.9 or more and less than 2. Such a range is favorable for the advantageous effects of the present invention.

In the present invention, 95% or more of the atoms in the (meth)acrylate monomer preferably consists of carbon atoms, oxygen atoms, and hydrogen atoms. More preferably, 100% of the (meth)acrylate monomer consists of carbon atoms, oxygen atoms, and hydrogen atoms.

The alignment film containing a (meth)acrylic resin in the present invention preferably has polar groups, which are preferably hydroxyl groups. An alignment film having hydroxyl groups tends to have high adhesiveness with a transparent support.

The (meth)acrylate monomer forming an alignment film containing a (meth)acrylic resin is preferably a combination of a compound containing one (meth)acryloyl group in one molecule and a compound containing two or more (meth)acryloyl groups in one molecule and more preferably a combination of a compound containing one (meth)acryloyl group in one molecule and a compound containing two to four (meth)acryloyl groups in one molecule.

The (meth)acrylate monomer in the present invention preferably has a molecular weight of 100 to 800 and more preferably 150 to 500.

Examples of the (meth)acrylate monomer include (meth)acrylic acid diesters of alkylene glycols, (meth)acrylic acid diesters of polyoxyalkylene glycols, (meth)acrylic acid diesters of polyhydric alcohols, (meth)acrylic acid diesters of ethylene oxide or propylene oxide adducts, epoxy(meth)acrylates, urethane(meth)acrylates, and polyester (meth)acrylates.

In particular, esters of polyhydric alcohols and (meth)acrylic acid are preferred. Examples of the esters include glycerin monomethacrylate (GLM), 1,6-hexanediol acrylate, pentaerythritol tetra(meth)acrylate (PETA), pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, urethane acrylate, polyester polyacrylate, and caprolactone-modified tris(acryloxyethyl)isocyanurate.

Commercially available (meth)acrylate monomers may also be used. Examples of multifunctional acrylate compounds having (meth)acryloyl groups include KAYARAD series PET30, DPHA, DPCA-30, and DPCA-120 manufactured by Nippon Kayaku Co., Ltd. Examples of the urethane acrylate include U15HA, U4HA, and A-9300 manufactured by Shin-Nakamura Chemical Co., Ltd. and EB5129 manufactured by Daicel-UCB Co., Ltd.

The alignment film containing a (meth)acrylic resin can be more preferably formed by coating a composition in a transparent support, where the composition contains a (meth)acrylate monomer having a ratio Y (number of carbon atoms)/M (number of atoms other than carbon and hydrogen atoms) of 1.4 or more and less than 3 and a solvent capable of dissolving or swelling the main component for the alignment film containing a (meth)acrylic resin and the main component of the support and then curing the (meth)acrylate monomer. In the use of the solvent capable of dissolving or swelling the main component for the alignment film containing a (meth)acrylic resin and the main component of the support, the solvent dissolves or swells the support and the alignment film containing a (meth)acrylic resin during the process of forming the alignment film. Subsequently, the solvent is volatilized to form an intermediate layer composed of the main component of the support and the main component of the alignment film containing a (meth)acrylic resin. The solvent having the dissolving or swelling ability is preferably volatilized by the above-described drying process. Alternatively, drying can be performed by heating, for example, during the subsequent process of forming the optically anisotropic layer. Air drying can be also employed. The solvent in the present invention preferably has abilities of both dissolving and swelling the main component for the alignment film containing a (meth)acrylic resin and the main component of the support.

The solvent capable of dissolving or swelling the main component for the alignment film containing a (meth)acrylic resin and the main component of the support indicates a solvent having high compatibility with the main component for the alignment film containing a (meth)acrylic resin and the main component of the support. The solvent can be properly selected depending on the ability of dissolving or swelling the resin used for the support.

From the viewpoint of swelling the support and the alignment film containing a (meth)acrylic resin to increase the adhesiveness, the solvent preferably contains at least one selected from the group consisting of cyclohexanone, methyl isobutyl ketone, toluene, methyl cyclohexane, and methyl acetate, and more preferably contains methyl acetate and methyl isobutyl ketone. These compounds may be used alone or in combination of two or more thereof.

A solvent capable of dissolving the main component for the alignment film containing a (meth)acrylic resin and the main component of the support is defined as follows: A support film of 24 mm×36 mm (thickness: 80 μm) is immersed in the solvent in a 15-cm³ vial at room temperature (25° C.) for 60 seconds and is then taken out, and the remaining solution is analyzed by gel permeation chromatography. A solvent satisfying the definition has a peak area of the main component for the support film of 400 mV/sec or more. Alternatively, a solvent capable of dissolving the main component of the support is defined as follows: a support film of 24 mm×36 mm (thickness: 80 μm) is immersed in the solvent in a 15-cm³ vial at room temperature (25° C.) for 24 hours while the vial being appropriately shaken. A solvent that can completely dissolve the film satisfies the definition.

A solvent capable of swelling the main component of the support is defined as follows: A support film of 24 mm×36 mm (thickness: 80 μm) is immersed in the solvent in a 15-cm³ vial at room temperature (25° C.) for 60 seconds while the vial being appropriately shaken. A solvent causing observable bending or deformation due to changes in dimensions of the swollen film satisfies the definition. In a solvent not having a swelling ability, no changes such as bending and deformation are observed).

In order to control the effect of the solvent, the solvent may be used together with a solvent incapable of dissolving and swelling the main component for the alignment film containing a (meth)acrylic resin and the main component of the support.

Examples of the solvent not having the dissolving ability and the swelling ability include methanol and ethanol.

The amount of the solvent not having the dissolving ability and the swelling ability is preferably 20% by mass or less, more preferably 10% by mass or less, and most preferably 1% by mass of less based on the total mass of the total solvents.

The alignment film containing a (meth)acrylic resin preferably has a thickness of 0.1 to 10 μm, more preferably 0.4 to 3.0 μm, and most preferably 1.0 to 2.0 μm.

### <<<Alignment Film Having High Alignment Regulating Force>>>

The alignment film having a high alignment regulating force can decrease the alignment distribution of the liquid crystal compound in a microscopic area, and any alignment film having such a property can be used. Preferred examples of the material used for forming the alignment film having a high alignment regulating force include the copolymer compounds described in paragraphs [0014] to [0016] of Japanese Patent Laid-Open No. 2002-98836, in particular, the copolymer compounds described in paragraphs [0024] to [0029] and [0173] to [0180]. Other preferred examples of the material include the copolymer compounds described in paragraphs [0007] to [0012] of Japanese Patent Laid-Open No. 2005-99228, in particular, the copolymer compounds described in paragraphs [0016] to From the viewpoint of improving the adhesion between the alignment film and the optically anisotropic layer, it is more preferred to introduce a polymerizable group, such as a vinyl group, into the structural unit of each of the copolymers described in these patent documents.

### <<<Photo-Alignment Film>>>

The photo-alignment film expresses an alignment function by light irradiation. The material for forming the photo-alignment film is preferably a compound having a photo-alignment group that expresses a photo-alignment function, for example, compounds having photoisomerizable alignment groups, such as an azo group, and compounds having photodimerizable alignment groups, such as a cinnamoyl group, a coumarin group, and a chalcone group. Preferred examples of the compound also include compounds having a group expressing the alignment function by photocrosslinking, such as a benzophenone group, and compounds expressing the alignment function by photolysis, such as polyimide resins.

The photo-alignment film can be formed by coating in a transparent support a material for the photo-alignment film, for example, a composition containing a compound having a photo alignment group. The photo-alignment film is preferably formed by preparing the composition as a coating solution, coating the coating solution onto a surface of, for example, a substrate, and drying it. Specifically, the photo-alignment film is preferably formed by preparing a coating solution by dissolving or dispersing the compound having a photo-alignment group and other components in an appropriate solvent and coating the coating solution onto a transparent support and is then drying it. The coating solution can be applied by any known process (e.g., spin coating, wire-bar coating, extrusion coating, direct gravure coating, reverse gravure coating, or die coating).

The photo-alignment film preferably has a thickness of 0.01 to 2 μm and more preferably 0.01 to 0.15 μm.

The light source used for light irradiation may be a usual light source such as a lamp (e.g., a tungsten lamp, a halogen lamp, a xenon lamp, a xenon flash lamp, a mercury lamp, a mercury/xenon lamp, or a carbon arc lamp), a laser (e.g., a semiconductor laser, a helium/neon laser, an argon ion laser, a helium/cadmium laser, or an YAG laser), a light-emitting diode, or a cathode-ray tube. The light for irradiation may be unpolarized light or polarized light. In the case of using polarized light, linearly polarized light is preferred. Alternatively, light of a wavelength necessary for irradiation may be selected with, for example, a filter or a wavelength converting element.

### <Polarizing Plate>

The present invention also relates to a polarizing plate at least including the optically-compensatory film of the present invention and the polarizing film.

The polarizing film and the optically-compensatory film of the present invention can be bonded to each other with an adhesive or a pressure-sensitive adhesive. The adhesive preferably has high transparency. Examples of the adhesive include polymer adhesives, such as acrylic polymer, vinyl alcohol polymer, silicone polymer, polyester, polyurethane, and polyether adhesives, isocyanate adhesives, and rubber adhesives. Examples of the pressure-sensitive adhesive include acrylic polymer, vinyl alcohol polymer, silicone polymer, polyester, polyurethane, polyether, isocyanate, and rubber pressure-sensitive adhesives.

The adhesive layer disposed between the polarizing film and the optically-compensatory film of the present invention is preferred to have a smaller thickness. For example, the thickness is preferably 50 μm or less, more preferably 10 μm or less, and most preferably 5 μm or less. The lower limit may be, for example, 1 μm, although it is not critical.

The polarizing film is prepared by, for example, dyeing a polyvinyl alcohol film with iodine and stretching the film.

A protective film is preferably bonded to the other surface of the polarizing film. Examples of the protective film include cellulose acylate, cyclic olefin polymers, acrylic polymers, polypropylene films, and polyethylene terephthalate (PET) films.

The protective film preferably has a thickness of 10 to 90 μm and more preferably 20 to 90 μm.

### <Liquid Crystal Display>

The present invention also relates to a liquid crystal display including the optically-compensatory film or the polarizing plate of the present invention. The liquid crystal display may be of an IPS mode or an FFS mode. In the present invention, the liquid crystal display may be any of transmissive, reflective, and transflective liquid crystal displays.

The usable IPS liquid crystal displays are described in, for example, Japanese Patent Laid-Open Nos. 2003-15160, 2003-75850, 2003-295171, 2004-12730, 2004-12731, 2005-106967, 2005-134914, 2005-241923, 2005-284304, 2006-189758, 2006-194918, 2006-220680, 2007-140353, 2007-178904, 2007-293290, 2007-328350, 2008-3251, 2008-39806, 2008-40291, 2008-65196, 2008-76849, and 2008-96815.

The FFS (hereinafter, also referred to as an FFS mode) liquid crystal cell includes a counter electrode and a pixel electrode. These electrodes are formed of transparent materials, such as ITO, with a width so that all of the components such as liquid crystal molecules arrayed above the electrodes can be driven between a space narrower than the distance between the upper and lower substrates. This structure allows an FFS mode to have an aperture ratio higher than that of an IPS (hereinafter, also referred to as an IPS mode). In addition, the electrodes have optical transparency; hence, the FFS mode can have a transmittance higher than that of the IPS mode. The FFS liquid crystal cell is described in, for example, Japanese Patent Laid-Open Nos. 2001-100183, 2002-14374, 2002-182230, 2003-131248, and 2003-233083.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments).

The selection of the measurement wavelength may be conducted according to the manual-exchange of the wavelength-selective-filter or according to the exchange of the measurement value by the program.

When a film to be analyzed is expressed by a monoaxial or biaxial index ellipsoid, Rth(λ) of the film is calculated as follows. Rth(λ) is calculated by KOBRA 21ADH or WR on the basis of the six Re(λ) values which are measured for incoming light of a wavelength λ nm in six directions which are decided by a 100 step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (21) and (22): PG

$$\begin{matrix}Re ( θ ) = [ ny - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} & ( 21 ) \\ Rth = \{ ( nx + ny ) / 2 - nz \} \times d & ( 22 )\end{matrix}$$

In the formula, Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

The instrument KOBRA-21ADH or KOBRA-WR calculates nx, ny, and nz, through input of the assumed average refractive index and the film thickness, and then calculates Nz=(nx−nz)/(nx−ny) on the basis of the calculated nx, ny, and nz.

Throughout the specification, the Re, Rth, and refractive index are measured at a wavelength of 550 nm, unless otherwise specified. The “in-plane slow axis” is the direction in which the in-plane refractive index is a maximum, and the “in-plane fast axis” is the direction orthogonal to the in-plane slow axis in the plane. The visible light region denotes a wavelength region of 380 to 780 nm.

### EXAMPLES

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### Example 1

### 1. Production of Transparent Support

A cellulose acylate was synthesized in accordance with the method described in Example 1 of Japanese Patent Laid-Open No. H10-45804, and the degree of substitution thereof was measured. Specifically, a carboxylic acid as a raw material of an acyl substituent and sulfuric acid (7.8 parts by mass) as a catalyst were added to 100 parts by mass of cellulose, and acylation was performed at 40° C. The type and the degree of substitution of the acyl group were adjusted by controlling the type and the amount of the carboxylic acid. After the acylation, the product was further aged at 40° C. The resulting cellulose acylate was cleaned with acetone to remove the low-molecular-weight components.

(Preparation of Cellulose Acylate Solution C01)

The following components were placed into a mixing tank and stirred for dissolving each component to prepare a cellulose acylate solution. The amounts of the solvents (methylene chloride and methanol) were appropriately controlled such that the cellulose acylate solution had a solid content of 22% by mass.

Cellulose acetate (the degree of substitution:
2.43): 100.0 parts by mass
Additive shown below, Compound A: 19.0 parts by mass
Additive shown below, Compound B: 5 parts by mass
Methylene chloride: 365.5 parts by mass
Methanol: 54.6 parts by mass

(Preparation of Cellulose Acylate Solution C02)

The following components were placed into a mixing tank and stirred for dissolving each component to prepare a cellulose acylate solution. The amounts of the solvents (methylene chloride and methanol) were appropriately controlled such that the cellulose acylate solution had a solid content of 22% by mass.

Cellulose acetate (the degree of substitution:
2.81): 100.0 parts by mass
Additive shown below, Compound A: 19.0 parts by mass
Methylene chloride: 365.5 parts by mass
Methanol: 54.6 parts by mass

A three-layer film comprising a core layer having a thickness of 62 μm from the cellulose acylate solution C01 and skin A layers each having a thickness of 2 μm from the cellulose acylate solution C02 was formed by co-casting with a band stretching machine. The resulting film had a thickness of 66 μm. The resulting web (film) was detached from the band, was held with clips, and was laterally stretched with a tenter. The stretching temperature was 193° C., and the draw ratio was 73%. After the clips were removed, the film was dried at 130° C. for 20 min to give a film having a thickness of 38 μm.

The resulting transparent support had a retardation in-plane Re of 102 nm and a retardation in the thickness direction Rth of 108 nm at a wavelength of 550 nm.

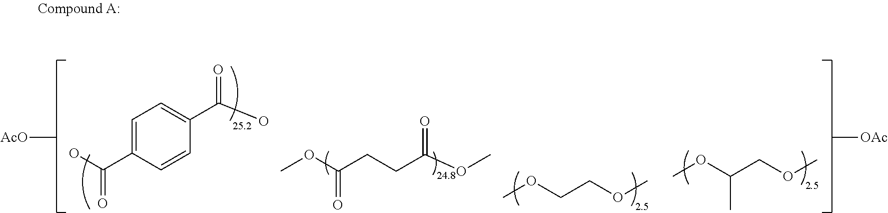

Ac represents an acetyl group.

Compound A represents a terephthalic acid/succinic acid/ethylene glycol/propylene glycol copolymer (copolymerization ratio [mol %]=27.5/22.5/25/25).

Compound A is a non-phosphate ester compound and is a retardation-developing agent. The terminals of compound A are capped with acetyl groups.

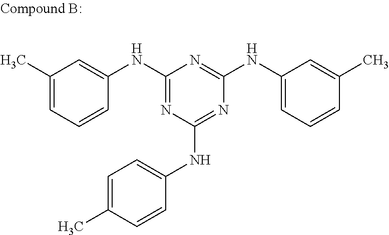

### 2. Formation of Alignment Film

A composition for forming an alignment film having a solid content of 30% was prepared by mixing 100 parts by mass of a mixture of two acrylic compounds (pentaerythritol tetraacrylate (PETA)/glycerin monomethacrylate (GLM)=100/50 (mass ratio)), 4 parts by mass of a photopolymerization initiator (Irgacure 127, manufactured by Ciba Specialty Chemicals Inc.), and a solvent mixture (methyl acetate:methyl isobutyl ketone=35:65 (mass ratio)). The prepared composition for forming an alignment film was applied onto a support with a wire bar coater #1.6 at a coating density of 8.4 mL/m², followed by drying at 40° C. for 0.5 minutes and then irradiation with 54 mJ of ultraviolet (UV) light at 30° C. for 30 seconds with a 120 W/cm high-pressure mercury lamp for crosslinking.

### 3. Formation of Optically Anisotropic Layer

The coating solution for an optically anisotropic layer described below was applied onto the alignment film with a wire bar coater #3.2 at a coating density of 6 mL/m². The resulting film was fixed to a metal frame, followed by heating at 100° C. for 2 minutes in a thermostat to align the rod-like liquid crystal compound (homeotropic alignment). The laminate was cooled to 50° C. and was irradiated with ultraviolet light at an illuminance of 190 mW/cm² and a dose of 310 mJ/cm² with a 160-W/cm air cooling metal halide lamp (manufactured by Eye Graphics Co., Ltd.) under nitrogen purging to provide an oxygen concentration of about 0.1% at 40° C. (UV ray temperature during the fixing process) to cure the application layer, followed by drying at 70° C. The Re(550) and the Rth(550) of the optically anisotropic layer were measured as in the case of the transparent support. The Re(550) was 0.1 nm, and the Rth(550) was −165 nm.

### <Composition of Coating Solution for Optically Anisotropic Layer>

Liquid crystal compound (a mixture of liquid crystal compound B01 and liquid crystal compound B02 at a mass
ratio of 90:10:100 parts by mass
Vertical alignment agent (S01): 1 part by mass
Adhesion enhancing agent: 0.25 parts by mass
Leveling agent: 0.8 parts by mass
Polymerization initiator: 3 parts by mass
Sensitizer: 1 part by mass
Acrylic binding agent: 8 parts by mass
Solvent: methyl ethyl ketone/cyclohexane (=86/14 (% by mass)) in an amount to give a solid content of 33% by mass 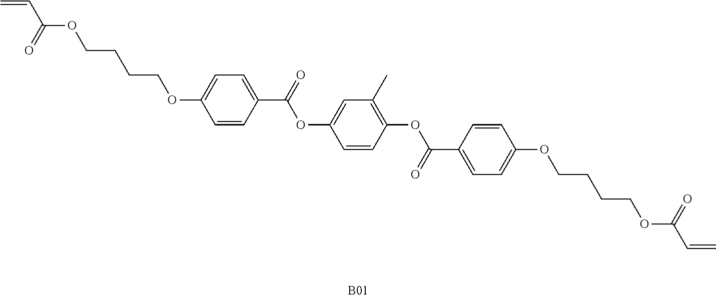 [SMILES: C=CC(=O)OCCCCOc1ccc(C(=O)Oc2ccc(OC(=O)c3ccc(OCCCCOC(=O)C=C)cc3)c(C)c2)cc1 ; "B01"] 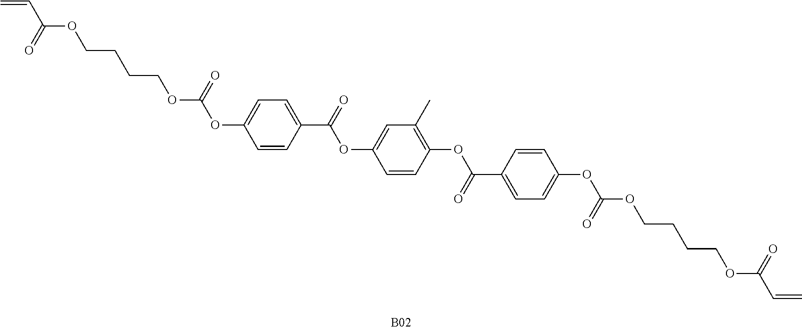 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1 ; "B02"] 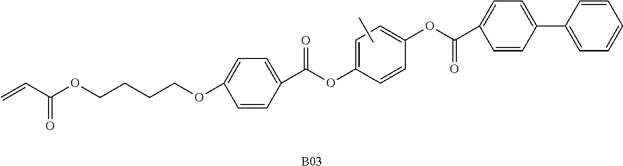 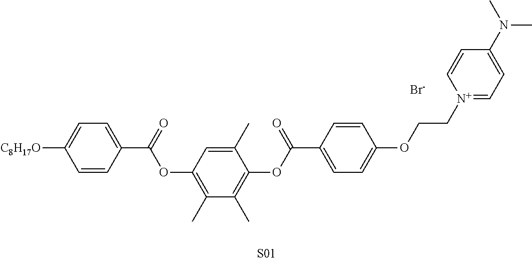
Adhesion enhancing agent: 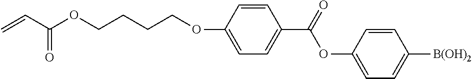 [SMILES: C=CC(=O)OCCCCOc1ccc(C(=O)Oc2ccc(B(O)O)cc2)cc1]
Leveling agent: 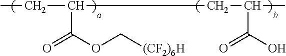
where, a:b is 90:10.
Polymerization initiator: 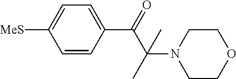
where, Me represents a methyl group.
Sensitizer: 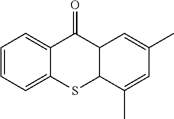 [SMILES: CC1=CC2C(=O)c3ccccc3SC2C(C)=C1]
Acrylic binding agent:

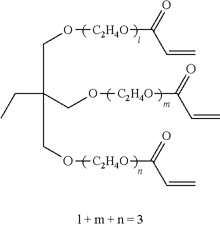

Optically-compensatory films of Examples 2 to 10 and Comparative Examples 1 to 2 were produced as in Example 1 except that the liquid crystal compound, the blending ratio of the liquid crystal compound, the UV light temperature during the fixing process, the solid content of the alignment film, and the drying temperature of the alignment film were varied as shown in Table 2.

TABLE 2

| | Optically anisotropic layer | | | | | Alignment film | |
|---|---|---|---|---|---|---|---|
| | | | | | UV ray | Solid | Drying |
| | | | | | temperature | content | temperature of |
| | | | Ratio of | | during the | of the | the alignment |
| | Liquid | Liquid | liquid crystal | Vertical | fixing | alignment | film at the time |
| | crystal | crystal | compound | alignment | process | film | of forming |
| | compound 1 | compound 2 | (mass ratio) | agent | (° C.) | (%) | (° C.) |
| Example 1 | B01 | B02 | 90/10 | S01 | 40 | 30 | 40 |
| Example 2 | B01 | B02 | 90/10 | S01 | 40 | 20 | 40 |
| Example 3 | B01 | B02 | 90/10 | S01 | 40 | 40 | 40 |
| Comparative | B01 | B02 | 90/10 | S01 | 40 | 60 | 40 |
| Example 1 | | | | | | | |
| Example 4 | B01 | B02 | 90/10 | S01 | 30 | 30 | 40 |
| Example 5 | B01 | B02 | 90/10 | S01 | 60 | 30 | 40 |
| Example 6 | B01 | B02 | 80/20 | S01 | 40 | 30 | 40 |
| Example 7 | B01 | B02 | 80/20 | S01 | 40 | 30 | 25 |
| Example 8 | B01 | B02 | 80/20 | S01 | 40 | 30 | 60 |
| Comparative | B01 | B02 | 70/30 | S01 | 40 | 30 | 40 |
| Example 2 | | | | | | | |
| Example 9 | B01 | B03 | 88/12 | S01 | 40 | 30 | 40 |
| Example 10 | B01 | B03 | 88/12 | S01 | 40 | 30 | 25 |

### 4. Production of Polarizing Plate

### <Formation of Adhesive Layer>

The optically-compensatory film in Example 1 was bonded to one surface of a polyvinyl alcohol polarizing film (thickness: 22 μm) with the adhesive shown below, and FUJITAC TD60UL (thickness: 60 μm) manufactured by Fuji Film Co., Ltd. was similarly bonded to the other surface of the polarizing film to produce a polarizing plate. The adhesive layer had a thickness of 20 μm.

### <Production of Adhesive>

An acrylate polymer to be used in the adhesive was prepared as follows.

A reaction vessel equipped with a cooling tube, a nitrogen gas inlet tube, a thermometer, and a stirrer was charged with 100 parts by mass of butyl acrylate, 3 parts by mass of acrylic acid, and 0.3 parts by mass of 2,2′-azobisisobutyronitrile, and ethyl acetate was added thereto to give a solid content of 30% by mass. The mixture was subjected to a reaction under a nitrogen gas flow at 60° C. for 4 hours to yield acrylate polymer (A1).

Subsequently, an acrylate adhesive was produced with the resulting acrylate polymer (A1) by the following procedure.

Two parts by mass of trimethylolpropane tolylene diisocyanate (Coronate L, manufactured by Nippon Polyurethane Industry Co., Ltd.) and 0.1 parts by mass of 3-glycidoxypropyltrimethoxysilane were added to 100 parts by mass of the solid content of the acrylate polymer (A1). The resulting mixture was applied to a separate film surface-treated with a silicone release agent with a die coater, and the coating was dried at 150° C. for 3 hours to give an acrylate adhesive. Coronate L (Nippon Polyurethane Industry Co., Ltd.) is a crosslinking agent having two or more aromatic rings.

### 5. Production of Liquid Crystal Display

### <Preparation of Liquid Crystal Cell>

The liquid crystal panel was detached from iPad (registered trademark) (trade name, manufactured by Apple, Inc.) including an IPS liquid crystal cell. Between optical films disposed on the front side (display side) and the rear side (backlight side) of the liquid crystal cell, only the optical film on the front side (display side) was removed. The front glass surface of the liquid crystal cell was cleaned.

### <Production of Liquid Crystal Display>

A polarizing plate having an optically-compensatory film was bonded to the surface of the IPS liquid crystal cell on the display side.

Thus, an IPS liquid crystal display (LCD) was produced.

The produced LCD was attached to the iPad and was evaluated as follows.

### 6. Evaluation

### <Retardation>

The retardation of each optically-compensatory film prepared above was measured by the above-described method.

### <Measurement of Degree of Depolarization>

An optical system composed of the light source of iPad, a polarizing film, a sample, a light analyzer, and a photodetector (SR-UL1R, manufactured by Topcon Corp.) was constructed such that the absorption axis of the polarizing film and the slow axis of the sample were orthogonal to each other. In the measurement of the degree of depolarization at the front, the polarizing film, the sample, the light analyzer, and the photodetector were arranged on the normal direction of the light source, and the minimum luminance Lmin and the maximum luminance Lmax were measured with rotating the light analyzer. In addition, the minimum luminance Lmin and the maximum luminance Lmax in a blank state not including the sample were measured with rotating the light analyzer. The degree of depolarization was calculated with the following expression:

Degree of depolarization=Lmin/Lmax−L₀min/L₀max

where
Lmin denotes the minimum luminance of the sample disposed between two polarizing plates in a cross nicol state;
Lmax denotes the maximum luminance of the sample disposed between two polarizing plates in a parallel nicol state;
L₀ min denotes the minimum luminance of two polarizing plates in a cross nicol state; and
L₀max denotes the maximum luminance of two polarizing plates in a parallel nicol state.

In the measurement of the degree of depolarization in an oblique direction, the polarizing film and the sample were arranged on the normal direction of the light source, and the light analyzer and the photodetector were arranged on a line in an oblique angle of 500 relative to the absorption axis of the polarizing film. The minimum luminance and the maximum luminance were measured with rotating the light analyzer. The degree of depolarization in an oblique direction was calculated with the same calculation expression as that in the measurement at the front.

### <Measurement of Order Parameter>

A horizontal alignment cell was produced by adding a dichroic dye to the coating solution for forming the optically anisotropic layer prepared above and using the coating solution and a horizontal alignment film. The absorbance “A_{∥}” of light polarized in parallel to the alignment of the liquid crystals and the absorbance “A_{⊥}” of light polarized perpendicular to the alignment of the liquid crystals were measured with V7070 manufactured by JASCO Corp. The order parameter was calculated with the following expression:

S=(A_{∥}−A_{⊥})/(2A_{⊥}+A_{∥}).

### <Evaluation of Front Contract (CR)>

Each of the IPS liquid crystal displays produced above was equipped with a backlight. The luminance during displaying a black picture and the luminance during displaying a white picture were measured with measuring instrument (EZ-Contrast XL88, manufactured by ELDIM). The front contrast ratio (CR) was calculated and was evaluated with the following criteria:

A: 900≦CR,

B: 850≦CR<900,

C: 800≦CR<850, and

D: CR<800.

### <Evaluation of Upward Viewing Angle CR>

Each of the IPS liquid crystal displays produced above was equipped with a backlight. The luminance during displaying a black picture and the luminance during displaying a white picture were measured with measuring instrument (EZ-Contrast XL88, manufactured by ELDIM). The average of contrast ratios (CRs) in vertical angles (at azimuth angles of 900 and 2700 in a polar angle of 500) was calculated and was evaluated with the following criteria:

A: 400≦CR,

B: 370≦CR<400,

C: 340≦CR<370, and

D: CR<340.

### <Evaluation of Viewing Angle CR>

Each of the IPS liquid crystal displays produced above was equipped with a backlight. The luminance during displaying a black picture and the luminance during displaying a white picture were measured in a dark room with a measuring instrument (EZ-Contrast XL88, manufactured by ELDIM). The average of the minimum values at the first to fourth quadrants in the direction of a polar angle of 600 was defined as a viewing angle contrast ratio (viewing angle CR) and was calculated. The results were evaluated by the following criteria:

A: 100≦viewing angle CR,

B: 90≦viewing angle CR<100,

C: 80≦viewing angle CR<90, and

D: viewing angle CR<80.

In Comparative Example 3, the front polarizing plate and the optically-compensatory film including liquid crystal compounds were peeled from iPhone 4 (Apple, Inc.), and evaluation was performed.

In Comparative Example 4, the front polarizing plate and the optically-compensatory film including liquid crystal compounds were peeled from 37Z3500 (TV, manufactured by Toshiba Corp.), and evaluation was performed.

TABLE 3

| | | | | | Degree of | | | | Upward | |
|---|---|---|---|---|---|---|---|---|---|---|
| | Transparent | | Optically | | depolarization | | | | viewing | Viewing |
| | support | | anisotropic layer | | | Polar angle | Order | | angle | angle |
| | Re (nm) | Rth (nm) | Re (nm) | Rth (nm) | Front | of 50° | parameter | Front CR | CR | CR |
| Example 1 | 102 | 108 | 0.1 | −163 | 0.000018 | 0.00067 | 0.60 | A | B | B |
| Example 2 | 101 | 108 | 0.1 | −165 | 0.000019 | 0.00065 | 0.58 | A | B | B |
| Example 3 | 101 | 109 | 0.0 | −164 | 0.000018 | 0.00069 | 0.57 | A | B | B |
| Comparative | 102 | 108 | 0.0 | −164 | 0.000020 | 0.00091 | 0.51 | A | D | B |
| Example 1 | | | | | | | | | | |
| Example 4 | 101 | 108 | 0.0 | −163 | 0.000019 | 0.00063 | 0.61 | A | B | B |
| Example 5 | 102 | 109 | 0.0 | −164 | 0.000019 | 0.00065 | 0.61 | A | B | B |
| Example 6 | 102 | 108 | 0.1 | −163 | 0.000019 | 0.00059 | 0.63 | A | A | A |
| Example 7 | 101 | 107 | 0.1 | −164 | 0.000019 | 0.00057 | 0.63 | A | A | A |
| Example 8 | 102 | 108 | 0.1 | −165 | 0.000018 | 0.00063 | 0.61 | A | B | B |
| Comparative | 102 | 108 | 0.0 | −165 | 0.000019 | 0.00080 | 0.53 | A | D | B |
| Example 2 | | | | | | | | | | |
| Example 9 | 101 | 107 | 0.0 | −164 | 0.000019 | 0.00056 | 0.65 | A | A | A |
| Example 10 | 102 | 108 | 0.1 | −163 | 0.000018 | 0.00054 | 0.65 | A | A | A |
| Comparative | — | — | — | — | 0.000026 | 0.00105 | 0.51 | C | D | D |
| Example 3 | | | | | | | | | | |
| Comparative | — | — | — | — | 0.000023 | 0.00083 | 0.53 | C | C | C |
| Example 4 | | | | | | | | | | |

The results shown in Table 3 demonstrate that the optically-compensatory films of the present invention are excellent in front contrast, oblique direction contrast, and viewing angle contrast. In contrast, Comparative Examples of which the degrees of depolarization not satisfying the requirements of the present invention were inferior to the optically-compensatory film of the present invention in at least one of the front contrast, oblique direction contrast, and viewing angle contrast.

Examples Using Polymer Film for Thin Film

Dope P10 and dope T30 having compositions shown below were prepared.

### Composition of Dope P10:

Dianal BR88 available from Mitsubishi Rayon Co., Ltd.: 100.0 parts by mass

Additive AA1: 5.8 parts by mass

Additive AA2: 1.8 parts by mass

Additive UU1: 2.0 parts by mass

### Composition of Dope T30:

Cellulose acylate (the degree of substitution: 2.42): 100.0 parts by mass

Additive AA1: 5.8 parts by mass

Additive AA2: 1.8 parts by mass

Additive UU1: 2.0 parts by mass

Additive AA1 is a compound represented by the following formula, wherein R represents a benzoyl group, and the average degree of substitution is 5 to 7.

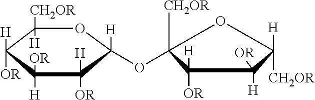

Additive AA2 is a compound represented by the following formula, wherein the structure and the degree of substitution of R⁹ are shown below.

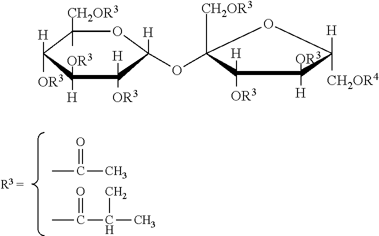

The degree of substitution of —C(═O)—CH₃ is 2.0 and the degree of substitution of —C(═O)—CH(CH₃)₂ is 6.0.

Additive UU1 is a compound represented by the following formula.

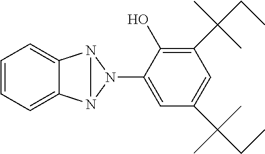 [SMILES: CCC(C)(C)c1cc(-n2n3c4ccccc4n23)c(O)c(C(C)(C)CC)c1]

A laminate film was produced by solution casting of dope P10 and dope T30. Specifically, the two dopes were co-cast onto a metal support through a casting T-die for three-layer co-casting. On this occasion, a lower layer (T30), an intermediate layer (P10), and an upper layer (T30) were cast in this order from the metal support surface side. The viscosity of each layer was appropriately controlled by its solid content depending on the combination of the dopes to allow uniform casting. The dopes were dried in a dry wind at 40° C. on the metal support to form a film. Subsequently, the film was peeled off and was dried in a dry wind at 105° C. for 5 minutes while the both ends of the film were pinched for keeping the distance therebetween constant. After removing the pins, the film was further dried at 130° C. for 20 minutes, and the laminate film was wound.

Subsequently, the lower layer of the three-layer laminate film was peeled off. The film of the lower layer had the same optical performances (Re=1.0 nm, Rth=35 nm) as those of the polymer film produced above and had a thickness of 20 μm. Thus, thin polymer film can be stably produced.

The thin film was arranged instead of the protective film of the polarizing film to produce each liquid crystal display having the same structure. These liquid crystal displays were similarly evaluated, and satisfactory results were obtained.

The present disclosure relates to the subject matter contained in Japanese Patent Application No. 135841/2013, filed on Jun. 28, 2013, Japanese Patent Application No. 109322/2014, filed on May 27, 2014, and Japanese Patent Application No. 123580/2014, filed on Jun. 16, 2014, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optically-compensatory film comprising:
a transparent support; and
at least one optically anisotropic layer comprising a liquid crystal composition containing liquid crystal compounds, in the transparent support;
wherein when the optically-compensatory film is disposed between two polarizing plates in a cross nicol state, degree of depolarization as seen from the front face is 0.000022 or less, and degree of depolarization as seen from a polar angle of 500 from an absorption axis direction of one of the polarizing plates is 0.00077 or less, wherein the degree of depolarization D is represented by
D=Lmin/Lmax−L₀min/L₀max
wherein
Lmin denotes the minimum luminance of the optically-compensatory film disposed between two polarizing plates in a cross nicol state;
Lmax denotes the maximum luminance of the optically-compensatory film disposed between two polarizing plates in a parallel nicol state;
L₀min denotes the minimum luminance of two polarizing plates in a cross nicol state; and
L₀max denotes the maximum luminance of two polarizing plates in a parallel nicol state.

2. The optically-compensatory film according to claim 1, wherein the liquid crystal compounds are vertically aligned.

3. The optically-compensatory film according to claim 1, wherein the liquid crystal compounds have a polymerizable group, and the liquid crystal compounds after polymerization have an order parameter of 0.55 or more, wherein the order parameter S is represented by
S=(A_{∥}−A_{⊥})/(2A_{⊥}+A_{∥}),
wherein “A_{∥}” denotes absorbance of light polarized in parallel to the alignment direction of liquid crystal compounds; and
“A_{⊥}” denotes absorbance of light polarized perpendicular to the alignment direction of liquid crystal compounds.

4. The optically-compensatory film according to claim 1, wherein the liquid crystal composition contains at least two kinds of liquid crystal compounds selected from a liquid crystal compound represented by Formula (1), a liquid crystal compound represented by Formula (2), and a liquid crystal compound represented by Formula (3); 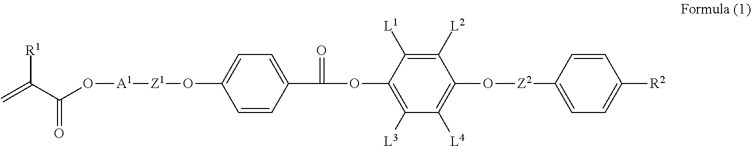
wherein A¹ represents a polymethylene group having 2 to 18 carbon atoms, in which one or non-adjacent two or more CH₂ groups of the polymethylene group are optionally substituted with —O—; Z¹ represents —CO—, —O—CO—, or a single bond; Z² represents —CO— or —CO—CH═CH—; R¹ represents a hydrogen atom or a methyl group; R² represents a hydrogen atom, a halogen atom, a linear alkyl group having 1 to 4 carbon atoms, a methoxy group, an ethoxy group, an optionally substituted phenyl group, a vinyl group, a formyl group, a nitro group, a cyano group, an acetyl group, an acetoxy group, an N-acetylamido group, an N-acrylamido group, an N,N-dimethylamino group, or a maleimide group; L¹, L², L³, and L⁴ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L¹, L², L³, and L⁴ represents a group other than a hydrogen atom; 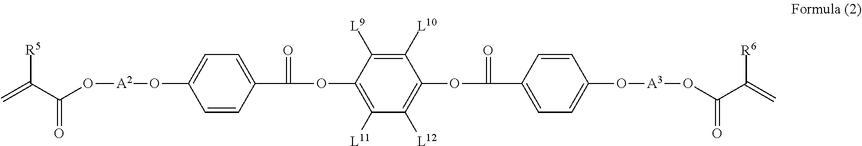
wherein A² and A³ each independently represent a polymethylene group having 2 to 18 carbon atoms, in which one or non-adjacent two or more CH₂ groups of the polymethylene group are optionally substituted with —O—; R⁵ and R⁶ each independently represent a hydrogen atom or a methyl group; L⁹, L¹⁰, L¹¹, and L¹² each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L⁹, L¹⁰, L¹¹, and L¹² represents a group other than a hydrogen atom; 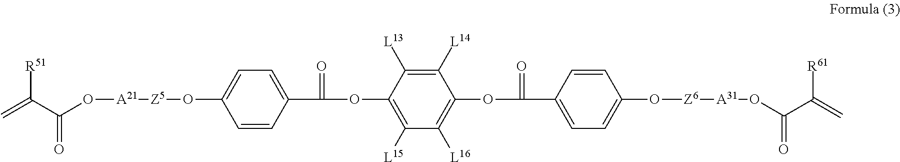
where, A²¹ and A³¹ each independently represent a polymethylene group having 2 to 18 carbon atoms, in which one or non-adjacent two or more CH₂ groups of the polymethylene group are optionally substituted with —O—; Z⁵ represents —CO— or —O—CO—; Z⁶ represents —CO— or —CO—O—; R⁵¹ and R⁶¹ each independently represent a hydrogen atom or a methyl group; L¹³, L¹⁴, L¹⁵, and L¹⁶ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom provided that at least one of L, L, L, and L represents a group other than a hydrogen atom.

5. The optically-compensatory film according to claim 4, wherein the two liquid crystal compounds are mixed at a mixing ratio of 80:20 to 95:5, the mixing ratio being mass ratio.

6. The optically-compensatory film according to claim 1, wherein the optically-compensatory film is formed by coating a liquid crystal composition containing liquid crystal compounds in a transparent support or on an alignment film disposed on a surface of a transparent support, aligning the liquid crystal compounds in a predetermined alignment state by maintaining the temperature at which the liquid crystal compounds form a liquid crystal phase, and fixing the alignment state of the liquid crystal compounds by ultraviolet ray irradiation at a predetermined temperature.

7. The optically-compensatory film according to claim 1, comprising an alignment film containing a (meth)acrylic resin between the transparent support and the optically anisotropic layer.

8. The optically-compensatory film according to claim 6, wherein the alignment film is formed by coating an alignment film composition containing a (meth)acrylic resin onto a transparent support and drying the coating at 10° C. to 60° C.

9. The optically-compensatory film according to claim 7, wherein the alignment film is formed by coating an alignment film composition having a solid content of 10% to 60% by mass onto a transparent support and drying the coating.

10. The optically-compensatory film according to claim 1, comprising an alignment film formed by coating an alignment film composition containing an acrylic resin onto a transparent support and drying the coated alignment film composition, wherein the optically-compensatory film is formed by aligning the liquid crystal compounds in a predetermined alignment state by maintaining the temperature at which the liquid crystal compounds form a liquid crystal phase and fixing the alignment state of the liquid crystal compounds by ultraviolet ray irradiation at 30° C. to 60° C.

11. The optically-compensatory film according to claim 1, wherein the optically anisotropic layer has a retardation in the thickness direction Rth(550) of −200 to −100 nm at a wavelength 550 nm.

12. The optically-compensatory film according to claim 1, wherein the transparent support has a retardation in-plane Re(550) of 70 nm or less and a retardation in the thickness direction Rth(550) of 0 to 200 nm at a wavelength 550 nm.

13. The optically-compensatory film according to claim 1, wherein the transparent support is a cellulose acylate-based film, a cyclic olefin polymer film, or an acrylic polymer film.

14. The optically-compensatory film according to claim 13, wherein the transparent support is formed of a composition containing a cellulose acylate including an acyl group having an aromatic group.

15. A polarizing plate comprising an optically-compensatory film according to claim 1 and a polarizing film.

16. The polarizing plate according to claim 15, wherein the optically-compensatory film and the polarizing film are directly bonded to each other with an adhesive and/or a pressure-sensitive adhesive.

17. The polarizing plate according to claim 15, comprising a protective film on the surface of the polarizing film at the opposite side of the optically-compensatory film.

18. The polarizing plate according to claim 17, wherein the protective film is selected from cellulose acylate-based films, cyclic olefin polymer films, acrylic polymer films, polypropylene films, and polyethylene terephthalate films.

19. The polarizing plate according to claim 17, wherein the protective film has a thickness of 10 to 90 μm.

20. The polarizing plate according to claim 15, wherein the polarizing film has a thickness of 50 μm or less.

21. An IPS mode or FFS mode liquid crystal display comprising an optically-compensatory film according to claim 1.

22. A method of producing an optically-compensatory film according to claim 1, the method comprising:
coating a liquid crystal composition containing liquid crystal compounds in a transparent support;
aligning the liquid crystal compounds in a predetermined alignment state by maintaining the temperature at which the liquid crystal compounds form a liquid crystal phase; and
fixing the alignment state of the liquid crystal compounds by ultraviolet ray irradiation at 30° C. to 60° C.

23. The method according to claim 22, comprising:
applying an alignment film composition containing a (meth)acrylic resin and having a solid content of 30% by mass or more onto a transparent support;
drying the coating at 10° C. to 40° C. to form an alignment film; and
coating a liquid crystal composition containing liquid crystal compounds onto the surface of the alignment film.
